(19) United States
(12) Patent Application Publication
(10) Pub. No.: US 2023/0343019 A1
(43) Pub. Date: Oct. 26, 2023

(54) VOLUME RENDERING IN DISTRIBUTED CONTENT GENERATION SYSTEMS AND APPLICATIONS

(71) Applicant: Nvidia Corporation, Santa Clara, CA (US)

(72) Inventor: Ingo Wald, Salt Lake City, UT (US)

(21) Appl. No.: 18/301,392

(22) Filed: Apr. 17, 2023

Related U.S. Application Data
(60) Provisional application No. 63/333,021, filed on Apr. 20, 2022.

(51) Int. Cl. G06T 15/06; G06T 1/20; G06T 15/00

(52) U.S. Cl. CPC G06T 15/06; G06T 1/20; G06T 15/005; G06T 2210/56

(57) ABSTRACT

Approaches presented herein provide for reduction in bandwidth and other resources used for lighting determinations in a rendering process. Sample locations for traced rays in a data volume can be determined by sampling a probability function based on random numbers and density values of macrocells through which those ray pass. Data for the macrocells may be stored and processed using different processors, and there may be no sample locations selected for a given macrocell, such as where the macrocell has a very low maximum density value. If it is determined that no sample locations are contained within a given macrocell through which a ray passes, the ray data is not forwarded to a processor for that macrocell but can instead be forwarded to the processor (if different) for a next macrocell that contains a sample location. Such an approach conserves resources and improves system efficiency by reducing the number of communications and processing operations to be performed.

### CROSS-REFERENCE TO RELATED APPLICATION

This application claims priority to and the benefit of U.S. Provisional Patent Application No. 63/333,021, filed Apr. 20, 2022, titled “REDUCING RAY BANDWIDTH IN DATA PARALLEL LIGHT TRANSPORT SIMULATION,” the full disclosure of which is hereby incorporated in its entirety for all purposes.

### BACKGROUND

In various applications—such as animation or online gaming, for example—there can be a need to render images—or video frames or other types of image data—representing various objects for a scene present in a digital or virtual environment. Approaches such as path tracing or volume rendering can be used to generate these images. In volume rendering, there may be a volumetric representation that has regions of varying density—such as a sky with scattered clouds having a higher water density—and a ray passing through these regions might only generate intersections at one or more of these regions, causing the path to scatter into multiple other paths. For large complex volumes, however, it may not be possible to store all the data in memory on a single processor, such as a single graphics processing unit (“GPU”). A volume can be partitioned and those different partitions allocated to different GPUs, for example, and data for a given ray can be passed between GPUs as that ray propagates through these different partitions. The need to send information for a large number of rays—potentially millions of rays—between processors in a ray forwarding-based data parallel rendering process can result in the consumption of a significant amount of bandwidth and need for additional storage for data buffering, which can impact performance of the rendering process for limited-resource computing systems. Existing approaches to improving performance of such a process often reduce prediction or bit count, for example, but such approaches can also result in a reduction in quality of the rendered images or video frames.

### BRIEF DESCRIPTION OF THE DRAWINGS

Various embodiments in accordance with the present disclosure will be described with reference to the drawings, in which:

FIGS. 1A and 1B illustrate an approach to tracing rays in a data volume with varying density, in accordance with various embodiments;

FIGS. 2A and 2B illustrate tracing rays in a partitioned data volume, in accordance with various embodiments;

FIGS. 3A and 3B illustrate example sample portions that can be selected based at least in part upon density information for a partitioned data volume, in accordance with various embodiments;

FIG. 4 illustrates an example system for determining light information for use in a rendering operation, in accordance with various embodiments;

FIGS. 5A and 5B illustrate example processes for rendering an image using determined light information that can be performed, in accordance with various embodiments;

FIG. 6 illustrates components of a distributed system that can be used to perform rendering and light determination, according to at least one embodiment;

FIG. 7A illustrates inference and/or training logic, according to at least one embodiment;

FIG. 7B illustrates inference and/or training logic, according to at least one embodiment;

FIG. 8 illustrates an example data center system, according to at least one embodiment;

FIG. 9 illustrates a computer system, according to at least one embodiment;

FIG. 10 illustrates a computer system, according to at least one embodiment;

FIG. 11 illustrates at least portions of a graphics processor, according to one or more embodiments;

FIG. 12 illustrates at least portions of a graphics processor, according to one or more embodiments;

FIG. 13 is an example data flow diagram for an advanced computing pipeline, in accordance with at least one embodiment;

FIG. 14 is a system diagram for an example system for training, adapting, instantiating, and deploying machine learning models in an advanced computing pipeline, in accordance with at least one embodiment; and

FIGS. 15A and 15B illustrate a data flow diagram for a process to train a machine learning model, as well as client-server architecture to enhance annotation tools with pre-trained annotation models, in accordance with at least one embodiment.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiments being described.

The systems and methods described herein may be used by, without limitation, non-autonomous vehicles, semi-autonomous vehicles (for example, in one or more advanced driver assistance systems (“ADAS”)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. Further, the systems and methods described herein may be used for a variety of purposes, by way of example and without limitation, for machine control, machine locomotion, machine driving, synthetic data generation, model training or updating, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, generative AI with large language models (“LLMs”), light transport simulation (for example, ray-tracing, path tracing, etc.), collaborative content creation for three-dimensional (“3D”) assets, cloud computing and/or any other suitable applications.

Disclosed embodiments may be comprised in a variety of different systems such as automotive systems (for example, a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more Virtual Machines (“VMs”), systems for performing synthetic data generation operations, systems implemented at least partially in a data center, systems for performing conversational AI operations, systems for performing generative AI operations using LLMs, systems for performing light transport simulation, systems for performing collaborative content creation for 3D assets, systems implemented at least partially using cloud computing resources, and/or other types of systems.

In at least one embodiment, lighting information can be obtained using ray or path tracing, where a sampling process is used to determine sample locations to obtain the lighting information. An image to be rendered can correspond to a view of one or more objects in a scene or environment, where the colors of different portions of the object(s) depend in part on the sources of light in the scene or environment, including reflections, refractions, transmissions, absorptions, or other potential sources of lighting that may be incident on a surface associated with specific pixels in the image based on the view. Data for the environment can include geometric data representative of the shapes of the objects, for example, as well as density information for the various objects as well as other portions of the environment. The portion of the virtual environment to be processed can be indicated by a bounding volume (e.g., bounding box) surrounding a data volume. The data volume can be a 3D volume, where each point or pixel location in the volume can be represented by a cell or voxel, and the color for the corresponding pixel may be determined through a process such as interpolation of the color values from the corners of the respective cell. The bounded data volume can be partitioned into a plurality of macrocells or other types of sub-volumes or partitionings. The macrocells can each represent different portions of the data, and the data for individual macrocells can be allocated for processing across one or more processing resources, such as different GPUs, so that no single processing unit is required to store and process all of the data for the data volume.

In order to determine the color values for individual pixels of an image to be rendered, one or more rays can be cast to determine lighting data that impacts the corresponding pixel. In order to reduce the amount of data to be processed, as well as the amount of time required for the processing, light sampling can be performed along the light path corresponding to the one or more rays. The density information can be used to select these sample locations, as regions of higher density—such as are associated with a solid object—are more likely to be associated with a light interaction than areas of low density—such as may be associated with a region of free space or air. In at least one embodiment, random numbers can be used with this density information in a probability density function (“PDF”) to determine the locations of these sample locations. This can include, for example, using the maximum density value or majorant for each macrocell. The sample locations can be determined along the light path, for example, where those sample locations are associated with cells that may be located in different macrocells that are associated with different processors. When sampling is completed in a given macrocell, the responsible processor can forward the ray data to the processor associated with the next macrocell for processing (unless the same processor is responsible for both macrocell s).

In many instances, however, a light path may pass through a number of macrocells, and there may not be a sample location in any of these macrocells. For example, the light path may pass only through a small corner of a macrocell, or the macrocell may not include any objects and thus may have a low maximum density value. In at least one embodiment, the processors for the macrocells can obtain the same random numbers for a light path and can obtain the maximum density information for every other macrocell, and can thus determine (or predict with high accuracy) where the sample locations will occur. If a processor determines that the next macrocell along the path will not include a sample location for the ray, then instead of forwarding the ray information to this next macrocell, the processor can instead forward the ray information to the processor associated with a subsequent macrocell where the next sample region is located (if one exists). In this way, ray data does not need to be forwarded to processors associated with regions where sampling will not occur, which can reduce the bandwidth needed for ray tracing, and can also reduce the processing and memory resources needed for these operations.

Variations of this and other such functionality can be used as well within the scope of the various embodiments as would be apparent to one of ordinary skill in the art in light of the teachings and suggestions contained herein.

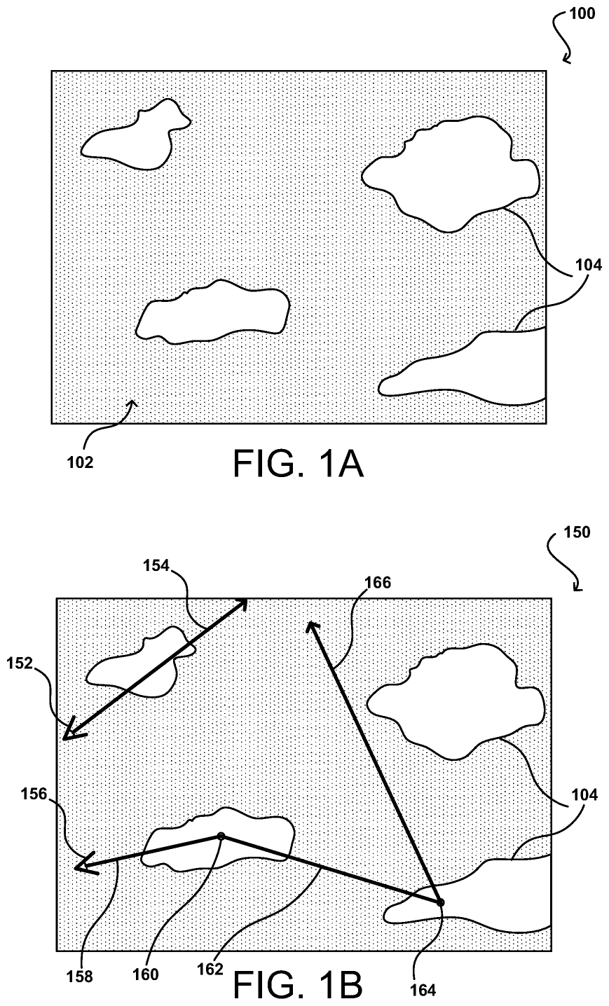

Approaches in accordance with various illustrative embodiments provide for the reduction in resource capacity—such as bandwidth and memory—needed to perform rendering tasks in a content generation system. Such a system can perform rendering using operations such as data parallel volume ray tracing applications. A scene (or portion of an environment) to be rendered may include one or more objects, such as clouds 104 in a 3D sky region 102 illustrated in an example rendered image 100 of FIG. 1A. In such a rendering process, the clouds will occupy various portions of the sky region determined by their respective geometry, as may be represented by a geometric mesh of volumetric representation. The appearance of the clouds in the sky can be determined not only by textures that may be mapped to the clouds 104, but also various lighting or shading effects used to determine the final color values of each pixel to be visible in the image that is associated with the clouds. Objects—such as clouds—are at least partially transmissive to visible light, where that transmissivity may depend at least in part upon the density or size of water droplets making up the clouds. For graphics rendering purposes, the clouds may simply have a transmissivity value set that indicates how rays traced for various light sources are to propagate through the clouds. For each pixel location associated with a cloud that is to be visible in the rendered image 100, the final color value can then be a combination of factors such as the color of the appropriate texture at that location, the intensity of incident light from all relevant light sources, and the reflectivity of the surface, among other such factors.

As an example, the image 150 of FIG. 1B illustrates example rays that can be traced for a given scene or environment in order to determine the impact of various lighting sources. A light path can be traced with respect to a particular viewpoint or light source, such as a first path (or ray) 154 traced for a first location 152 and a second path (including one or more rays) 158 traced for a second location 156. As illustrated, the first path 152 passes by or through the first cloud without an interaction, such as by not being reflected or scattered by a water droplet of the cloud, and thus can be determined not to impact the lighting of the scene. As illustrated, the second path 158 is determined to interact with a cloud at a determined interaction point 160, and thus will impact the color of a pixel associated with that point if that point is to be visible in a rendered image. As illustrated in FIG. 1B, the light path is also at least partially reflected or scattered from that point (and may be at least partially transmitted or refracted as well), which results in an additional ray 162 (or portion or path associated with the initially cast ray 156) that is then incident at a second interaction point 164 of another cloud, and then at least partially reflected as represented by an additional ray or path portion 166. In order to accurately light the scene, it may be appropriate to sample all possible rays from all possible locations, including all possible reflections, refractions, transmissions, absorptions, intersections, scattering, or other such interactions that may impact the behavior of light associated with that ray.

For a scene to be rendered, there may be many possible interactions—as may be on the order of hundreds of millions or more, depending at least in part upon factors such as the resolution and number of potential light sources—to be examined to determine an actual color value for each pixel. For many systems or environments, it can be prohibitively costly from at least a resource and time perspective to consider all this light information for each frame or image to be rendered. Even where sufficient resources may be available, the impact of many of these possible light interactions may be negligible with respect to the final rendered image. For these and other such reasons, a sampling of these light interactions can be performed to attempt to determine lighting for the scene in a realistic way while considering only a representative subset of the interactions. In at least one embodiment, approaches such as ray tracing, path tracing, or volume rendering can be performed that considers only a determined sampling of all possible light interactions for a scene. Such an approach can reduce the amount of data to be processed, while still providing highly accurate lighting effects for a rendered image that includes lighting or shading relating to shadows, indirect illumination, color bleeding, or global illumination, among other such possibilities.

In a volume rendering operation, there can be a bounding box associated with a scene that represents a 3D region or volume including objects that are to be rendered for an image of that scene. As in the example of FIG. 1A, there will typically be different portions of this volume that have different densities, such as portions of clouds versus portions including the sky, as well as differences in densities between different clouds. Volume path tracing is similar to surface ray tracing, where there is a camera and a path used to determine lighting effects associated with a shot ray. For surface ray tracing, the intersection is determined where the ray intersects with the surface, such as the surface of a given cloud. For volume ray tracing, however, the ray can pass through the volume and at some point within the volume might be determined to stochastically—using one or more random numbers—interact at one or more locations within the volume, such as to be at least partially reflected from the position of a water droplet in a cloud. A volume intersection can be determined at a given point, from which the path can be scattered, and another ray may be traced that may have a similar volume interaction, or may not interact with anything else in the volume.

In at least one embodiment, such a process may be performed on a single processor, such as on a single GPU. An operation such as delta tracking, among other such options, can be used to perform volume ray tracing and determine one or more intersection points. For delta tracking approaches that use Woodcock path tracing, for example, one or more random numbers can be used with the density of a given region through which a ray passes to determine an interaction point with respect to the volume. Density can be provided using any appropriate values, such as may be expressed in pounds per cubic inch or grams per cubic centimeter, among other such options, or may be normalized on a scale of 0 to 1 where an asset generator might assign solid objects a density value of 1 and empty spaces a density value of 0, with objects of medium density having values therebetween. As an example, the density of water can be set to about 1 g/ml, but might be assigned value of 0.2 on a normalized scale, where an average metal, steel, or any denser solid materials might be assigned a value of 1. The relative density values in a virtual environment may not correspond to actual differences in physical density values of these materials, but may be assigned by an artist or developer to obtain a desired look or performance.

It might be the case that a large scene includes a number of complex objects with varying densities. For an environment with various clouds in the sky, a weather simulation may have been performed to allow the density data to be simulated down to cubic inch resolution for a potentially large environment, as may involve multiple square acres or even miles for some scenes. For such a simulation, the density data alone may be quite large in size, such as on the order of 64 GB, 128 GB, or more, which may be unable in at least some systems to reside in memory on a single processor, or GPU.

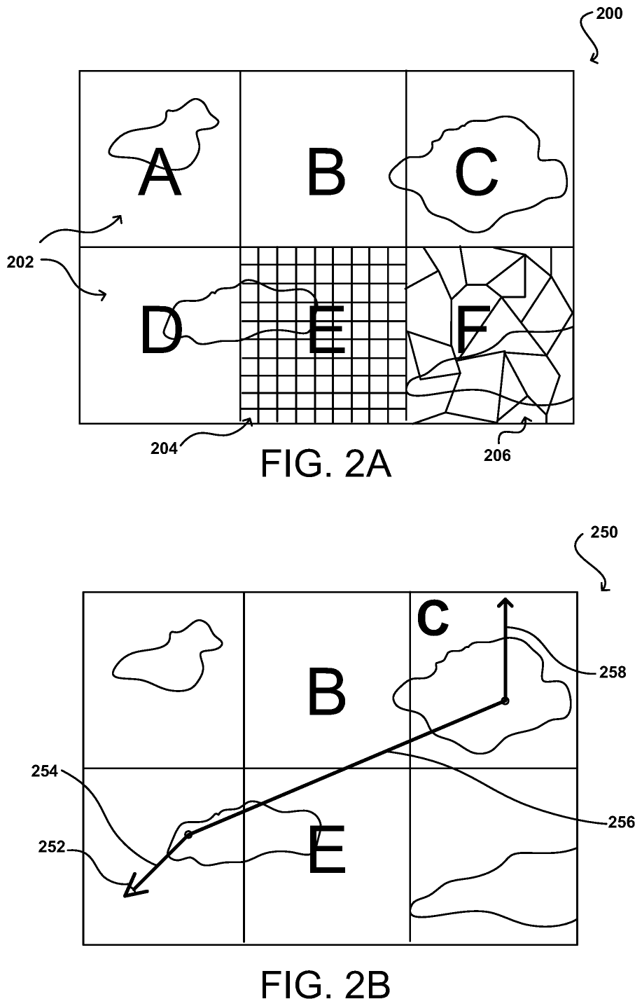

One approach to dealing with this large amount of data is to partition the volume that is to be used for the rendering (or other such purpose). As illustrated in the example volume image 200 of FIG. 2A, a given volume may be divided into a number of macrocells 202, here labeled macrocells A-F, which may be equal in size and shape in at least one embodiment. The number of macrocells may be configurable, may be determined based at least in part upon the number of available processors or the capacity of those processors, or may be determined based at least in part upon the complexity of the scene, among other such options. In this example, the volume is divided into six macrocells 202 for illustration purposes, although it should be understood that a volume will typically be 3D and as such might include additional macrocells not illustrated in this front view of the volume. Each macrocell may in turn comprise a number of 3D cells 204, or voxels or other partitionings, that may be used to determine color values for corresponding pixels to be rendered in a final image. As illustrated, individual cells may be regular 204 or irregular 206 in shape, and may involve individual cells of similar or different sizes, among other such options. An advantage to partitioning a volume into a number of smaller sub-volumes, or macrocells, is that the data for at least some of the different volumes can be processed using different GPUs. For example, the partitioning of FIG. 2A might allow the data for the six different macrocells to be sent to one, two, or up to six different GPUs for processing, as may depend upon factors such as current resource usage. Each GPU can then keep the respective portion of the data in memory, while no single GPU will be required to store all of the data for the volume.

The tracing of a path may then involve multiple macrocells where the data is stored by different processors. In the example volume ray tracing 250 of FIG. 2B, a ray might be traced starting at a given start location 252, which is then determined to interact with a point in a cloud in macrocell A. The light path is then at least partially reflected, causing a ray to pass through macrocells E and B, without interaction, until interacting with a point within a cloud in another macrocell C. The respective GPUs can process the light ray data using their portion of the data to determine the behavior of a ray in the respective macrocell, and can then pass the data for the ray or light path to the next macrocell along the path. Such an approach requires data to be passed between the respective GPUs for individual rays each time the ray passes between two macrocells. For complex scenes where rays may be redirected many times by a number of complex objects of varying density, and where there are a large number of rays to be cast, this can quickly result in a significant amount of additional data traffic used to transfer data between the various GPUs. For operations involving high-performance computing, there may be a large number of macrocells, which may be of regular or irregular shapes or different sizes, that may be associated with a number of different processors, processing cores, or processing units, many of which may need to receive information for a given light path. This additional need for significant bandwidth can negatively impact the performance of the system, and can also require significant additional but potentially unnecessary processing when a path passes through multiple macrocells, but may not interact with objects in at least some of those macrocells.

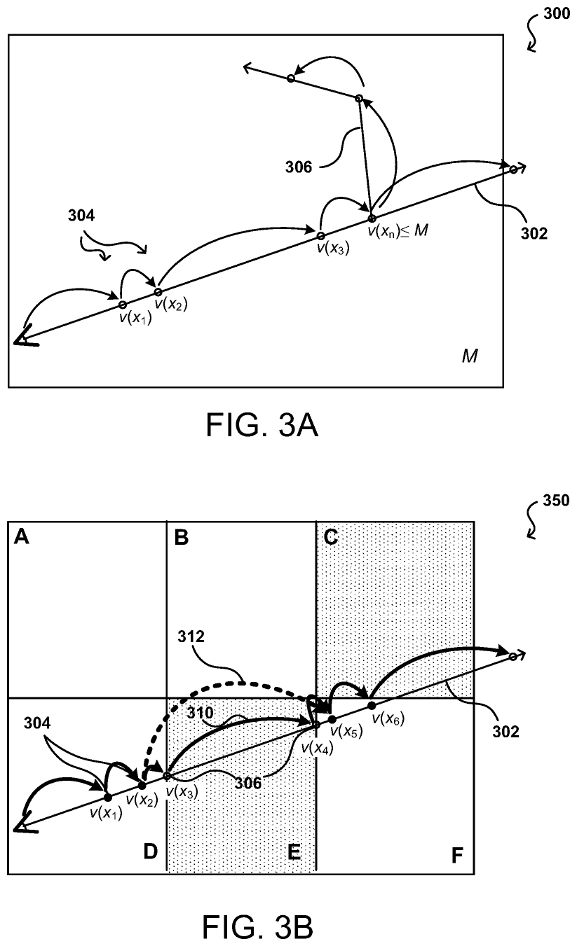

In at least one embodiment, an operation such as Woodcock tracking can be performed that uses data such as density data and a random number generator to determine a set of locations along a light path at which to evaluate each ray and its interaction locations in cells of a respective macrocell of a data volume. As illustrated in the example image 300 of FIG. 3A, a light path 302 can be traced through a volume, and a number of sample locations 304 can be determined. As mentioned, these sample locations can be determined or selected based at least in part upon the density in various portions of the volume, such that areas with lower density—such as the sky—may have few sample points selected, where areas with higher density—such as a cloud—may have more sample points selected. When combined with the random numbers used to determine the sample positions, it can be seen that there may be relatively long distances between some sample points. If a ray passes through a macrocell without one of these sample points being located in that macrocell, then there is no need in at least some embodiments to send the data for that ray to the GPU associated with that macrocell. If the densities and random numbers are known beforehand, a given GPU can also determine whether a given ray will have a sample point in a next macrocell through which the ray will pass, and if not then the GPU can forward the data to the GPU for the next region for which that ray will have a sample point, or may not need to forward the data at all (other than potentially result data) if there will be no more interactions for that ray in any of the macrocells. As illustrated, a light path may be directed in many different directions or bifurcated into multiple rays or paths 302, 306, where each path after each interaction may have a different intensity or power.

For example, consider the path 302 of FIG. 3A when viewed with respect to a number of macrocells A-F, as illustrated in FIG. 3B. An approach, such as Woodcock-based sampling or other density-based approaches, can be used to determine the sample points for the ray 302. If each GPU has the data used to determine these sample points, then each GPU can determine the same sample point locations using the same approach, operation, or algorithm. The processor for macrocell D can perform the respective operations at the two sample points within macrocell D. It can be determined that the next sample location will be in macrocell F, but there will be a step location at the boundary of macrocells D and E, and again at the boundary between macrocells E and F. When it is time to pass the data for the light path 302 to another processor, the next sample point can be determined and it can be determined that, although the ray will pass through macrocell E, there are no sample points to be evaluated in macrocell E. The processor storing data for macrocell D can then instead forward the data directly to the processor storing data for macrocell F. In this way, the number of communications needed for this ray is reduced by at least one message, as previously there would have been a communication between macrocells D and E, as well as between E and F, but now there is only a communication between macrocells D and F. Here, where there is no sample point in macrocell C, there would be at least one more reduction in communications as macrocell F would no longer have to send the data to the processor associated with macrocell C. For a large number of rays, such reduction in communications can significantly reduce the amount of system or processor bandwidth needed for those communications, and can also reduce the amount of processing needed by the various processors as there will be fewer evaluations to be performed as processors for macrocells without sample points for a given ray will not need to perform any evaluations for that ray, in at least some embodiments.

An approach such as Woodcock tracking has the benefit of being able to avoid at least some of the difficulties with free path sampling in content with varying volumetric density. Instead of inverting a cumulative distribution function of a path between intersections, for example, which can be computationally expensive for complex volumes, Woodcock tracking can perform sampling using a PDF to determine the location of sample points, or the path lengths between those sample points, which may correspond to potential interactions. As mentioned, portions of a volume with higher density are more likely to have at least one sample point selected than portions with lower density. If the random numbers are selected before processing, and passed to the respective processor(s), then each processor has the capability of determining all of the sample points along the ray, and can also determine the macrocells in which those sample points are located. This allows any given processor to determine all macrocells, or associated processors, for which the data for a given ray is to be forwarded. Such an approach can take advantage of ray forwarding-based data parallel rendering, but can use intelligent forwarding to only forward data for a given ray to the processor(s) that are to perform operations for that ray based on a sample point in the respective macrocell or domain associated with a given processor.

The data forwarded between any two processors for a given ray may depend in part on the renderer that is used. The data may include information such as the origin and direction of the ray in the volume, or other data useful in specifying the geometric ray being traced through the volume. The forwarded data may also include information indicating the pixel identifier or pixel location for which the ray would contribute in the event of an interaction of a certain type. Other information can be forwarded as well, such as light throughput, or how much of the light from a current location of the ray will actually pass back to the origin to or through the pixel, as each interaction of the ray can reduce an amount of light that propagates along the ray due to scattering or absorption, for example. The data forwarded between processors may not be substantially large, as may be on the order of around 64 bytes in size, but the large number of such messages can quickly add up if unnecessary messages are sent between processor, as there may be millions of rays cast for each individual image to be rendered in a sequence. The use of unnecessary bandwidth may be particularly problematic for certain communication mechanisms, such as where the communications are to be passed over a PCI bus or similar communication mechanism, or need to use network devices such as switches or routers. Even when approaches are taken to reduce the effective size of a ray, such as by using lower precision or lower bit count, the amount of data to be transferred can be excessive. By forwarding the ray data only to the processors that need the data, the overall speed of the shading and rendering process can be improved and the amount of bandwidth, storage, and processing can be reduced, resulting in significant increase in performance of the computer system(s) performing those and related operations.

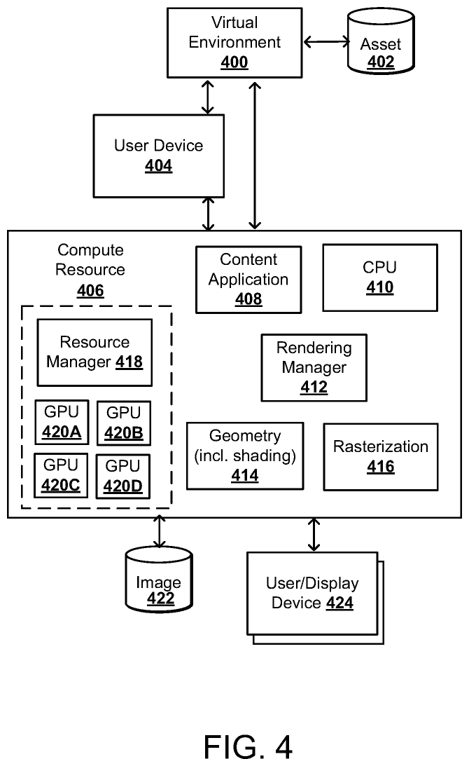

FIG. 4 illustrates an example system 400 for rendering an image, video frame, or other instance of image-related content in accordance with at least one embodiment. In this example, an image is to be rendered for a virtual environment 400, although images can be rendered for semi-virtual or real environments as well using such a system. The virtual environment 400 may include geometry and other data representative of shapes or objects in the environment, such as (3D objects that are representative, or are to be included in, a scene that occurs within the environment, as may include foreground objects such as people or vehicles, or background objects such as roads and buildings, among other such options. In at least some embodiments, at least some of the content for the scene may also be obtained from an asset repository 402, or other such location, which can contain content—such as geometry, textures, and density data—that can be used to render the scene. In at least some embodiments or instances, there can be a user device 404 running an content generation or management application that can allow a user to select assets from an asset repository 402 and at least a relevant portion of the virtual environment 400 to use in rendering the scene. The user device 404 can also allow a user to control aspects of the image to be rendered, such as the location or pose of an object in the scene, as well as a viewpoint and other parameters of a virtual camera to be used to render an image of the virtual environment 400.

In this example, at least one compute resource 406 is used to perform the rendering. This resource may correspond to one or more servers, for example, that may be located locally or across at least one network, among other such options. In some embodiments, the rendering may instead be at least partially performed on the user device 404. The compute resource 406 may obtain or receive data to be used for the rendering, as may include geometry, texture, and density data for the virtual environment 400 or assets from the asset repository 402, as well as information about the locations and poses of those objects in the scene and parameters of a virtual camera to be used to determine the view of the scene to be rendered. This information may be received to a content application 408, for example, that may be executing on a central processing unit (“CPU”) 410 of the compute resource 406 that is responsible for tasks such as collecting data, causing an image 422 to be rendered, and performing any formatting or encoding of a produced image, among other such operations. The content application 408 can work with a rendering manager 412, for example, which can be responsible for coordinating operations of a rendering pipeline executing on the compute resource 406, as may include modules 414, 416 or processes responsible for tasks such as geometry related tasks (including modules for lighting and shading tasks (414) and rasterization (416), among other such tasks). In at least some embodiments, at least some of these rendering tasks may be performed using one or more GPUs 420A-D of the compute resource 406, as well as potentially one or more processors or compute instances (physical or virtual) of one or more other compute resources.

A task such as ray tracing or volumetric sampling can be performed using a single processor, such as a single GPU, or can have operations distributed across multiple GPUs 420A-D. In this example, there can be a pool or set of GPUs 420A-D, and a resource manager 418 can be at least partially responsible for allocating a GPU to perform the processing for an operation. If, as discussed for a volumetric sampling approach with multiple macrocells, it is desired or beneficial to use more than one GPU, then the resource manager 418 can allocate one or more GPUs having the appropriate capacity or capabilities. This can include allocating a number of GPUs indicated in a request, or determining a number of GPUs to allocate based in part on the request. For example, there may be four macrocells, but based on the size of the volumes and the capacity of the GPUs these may be able to be hosted on one, two, three, or four GPUs (or other processing devices), with more than one macrocell potentially able to be hosted on a single GPU. In some embodiments, the resource manager may also be able to monitor an available bandwidth or memory in order to determine which and how many GPUs to allocate, such as where having high bandwidth capacity can allow operations to be spread across more GPUs, where bandwidth impact due to forwarding ray information will not be as critical, while having a bandwidth constrained system may cause the resource manager to attempt to allocate as few GPUs as possible in order to attempt to reduce the number of forwarding messages required.

In at least one embodiment, it can be determined by a rendering manager 412 that a volume for rendering is too large to be replicated, but macrocell information that a given processing node is to compute is significantly smaller than the volume itself, and can thus more likely be replicated across all nodes. In such an instance, though a given processing node may be unable to sample the volume data stored on another processing node—or other GPU storing data for a different macrocell—the processing node can likely still have a copy of the macrocell (or k-d tree, etc.) acceleration structure. Further, if a first processing node has access to or can determine the (pseudo-) random number sequence that a subsequent or second node would use for a given ray, that first processing node can also predict whether the second node would ever need to perform a sample. The first processing node can use the same random number sequence, traverse the ray through its local copy of the acceleration structure of the second node, and determine whether the second node would have taken any sample. Together, this can be used to avoid some ray forwardings that would not have produced any useful results. Using such an approach, the first node could effectively trace the ray through the acceleration structure of the second node before forwarding sending the ray to the second processing node, and if so could determine that the second node would not actually take any samples, and then could forward the ray directly to another node that the first processing node has determined would take at least one sample, or may not forward the ray at all if no other processing nodes will take samples for that ray.

In at least one embodiment, a partitioning of a data volume can be performed by a rendering manager 412, for example, and the assigning of data volumes to different processors can be performed by a resource manager 418 of the system. The resource manager 418 can receive information from the rendering component as to the number of partitions, and the respective size(s) of those partitions, and can select appropriate processors from a pool of available processors (i.e., GPUs 420A-D) or processor capacity. In some embodiments, the rendering application can choose the partitioning, while in other embodiments the renderer may have no control over the partitioning, which may be done by a separate management component (not illustrated in FIG. 4). In some embodiments a structured grid might be used such that a given volume is always partitioned into a fixed number of partitions, or macrocells, of equal or otherwise pre-determined relative size and shape.

Such an approach can be used advantageously for an approach where samples are taken at regular intervals. At each of these intervals, the volume can be queried at the respective sample point to compute an attenuation, or other such value, at that sample position. The processor for the macrocell with that sample point can then determine the processor for the macrocell containing the next sample point based on the fixed interval, and can forward the ray data to the determined processor.

Such an approach can also be used advantageously for an approach where samples are not taken at regular intervals, but intervals selected based at least in part upon the content of a given scene, such as the densities of objects in the scene. As mentioned, these sample positions can be determined using any appropriate algorithm as approach, such as for delta tracking or Woodcock tracking. For such an approach, the density values across a given volume can be known. In at least some embodiments, the density information will be in, or obtainable from, the input data set for an object, environment, or scene. If the density at various locations in a volume is known, then a determination can be made as to the probability of a ray (or particle, etc.) projected along a path through the volume being absorbed, or otherwise having an interaction, at any distance along that path. There is thus an exponential distribution of how far every particular ray or particle might propagate within that volume. Based on this, a random number can be generated and used to compute the distance that a ray or particle would be expected to travel. This randomly chosen distance can then correspond to a location where a sample is taken. Based on the probability that the sample was taken at that distance or location it can be inferred that the correct value was obtained. At that sample location, there can be some scattering or absorption such that the amount of light would drop off. For a non-homogenous volume, the maximum density M can be determined. Knowing the maximum density for a region, a computation can be made as to how far a given ray or particle would travel within that region or volume based at least in part upon the maximum density. The volume can then be queried at that location, such as to call the model of the environment for a value, which will be less than or equal to the maximum (or maj orant) density M. A sample can then be performed at that location to obtain a value. A second random number can then be selected that is proportional to M, or to the ratio of volume to M. If the density is 80% of M, and the random number is less than 0.8, then the system can accept this point because it is close enough to the value that was determined. Otherwise, the value can be rejected, and another Woodcock step can be taken. A delta- or Woodcock- based process can then become a sequence of steps performed at randomly selected distances. At each of these sample locations, rejection sampling can be performed to determine whether or not to keep the value for that sample location. If it turns out that the random number chosen selected to the density of the volume (or macrocell) is so high that the distance causes the next sample location not to be in a next macrocell through which the ray passes, but a subsequent volume, then there is no processing to be done for that ray in the next macrocell and the data can be forwarded to the subsequent volume, and associated processor, for processing. Each volume can then obtain either a maximum density value for the other macrocells, or density information that allows determination of a maximum density value for each macrocell.

In some embodiments, a given region or macrocell can further be divided into a set of macrocells, and determinations can be made as to which of these macrocells will have sample points, such that processing can be reduced. In some embodiments, this can be beneficial even where all of a volume may fit in memory on a single GPU. The process can still build a type of grid, k-d tree, bounding volume hierarchy (“BVH”), or other representation over the volume to partition into regions, where there will be different densities associated with each region. The macrocells can be arranged into a hierarchy as well, which can help to further reduce processing needed for a given ray by skipping processing for all child cells of a microcell with no sample points. Such an approach effectively determines where to place a sample point to detect an interaction of a ray or particle with the given volume.

As mentioned, a process such as Woodcock tracking can be used for determining step sizes or sample locations for a ray or path. As mentioned, the step size can be determined based at least in part upon the maximum density or maj orant of a given region through which the path will pass. A virtual cross section can be determined that represents the majorant of all cross-sections in the volume, where the cross section can be given by:

$${\sum }_{max} \geq max ( {\sum }_{i} ( r ) )$$

A PDF can then be sampled, as may be given by:

$$f ( x ) = {\sum }_{max} {e}^{- {\sum }_{max} x}$$

The PDF can be sampled to select a path length to a next sample location, which, based in part upon the relative density information, should be relatively close to a light interaction location. The location can be accepted or rejected with respective probabilities to account for the user of a virtual rather than an actual cross-section. Such an approach can provide for meshless particle or ray tracking that does not require surface-to-surface tracking. It should be understood that there may be other approaches used to determine the expected sample locations along a path or ray as well, and that such approaches may be based on density or other such factors of the objects or environment to be rendered. Other approaches may use the probability of a sample location being in a macrocell to determine whether to sample a ray or path, or may select sample locations specifically to attempt to avoid macrocells with low probability, maximum density, or portion of the overall path length. As mentioned, fixed sample sizes can be used as well, where an amount of absorption is determined at each regularly-spaced sample location. These approaches can be used with various types of volumetric representations as well, as may include structured or unstructured volumes, octrees, BVHs, and the like.

Multiple rays can also be traced with their results combined or averaged, in order to obtain an accurate result that may not be obtainable, or at least difficult to obtain, using a single ray. In at least one embodiment, Monte Carlo integration can be performed where many rays are traced and the results averaged together. In such an approach, each ray can obtain one or more random numbers from a random number generator that will be used throughout the entire traversal of the ray. An advantage of such an approach is that once the random numbers and algorithm are obtained, any given macrocell can calculate where sample locations will occur for a given ray. If a processor for a macrocell can predict or determine the values to be output from the random number generator and knows at least the relevant data—such as the maximum density—of other macrocells, then the processor can determine whether a sample location will be located within a given macrocell. The random number can be generated in any appropriate range, such as to generate a value between 0 and 1. An exponential (or other appropriate) function can then be sampled that is a function of the random number and the appropriate maximum density. The result is the distance the ray or path should step until the next sample point. The ray data can then be forwarded to the processor associated with the macrocell or microcell, for example, in which the next sample location is to be located (unless the processor is the same as for the prior sample location or the prior sample location is the last sample location along the path). And the actual density at the sample location can be determined with respect to the maximum density for that macrocell as discussed in more detail elsewhere herein to determine whether to accept or reject that point. If the sample point is accepted then an interaction can be determined or processed, such as to determine a scattering, reflection, or absorption, or if rejected then another step can be taken. While it is possible that such an approach may result in a sample location missing an important interaction, such as where the ray should intersect with a wall rather than pass through, the relatively density of the wall with respect to the surrounding environment should be such that there will be a high probability of the ray interacting with the wall rather than passing through the wall. There will also be a relatively low probability of the sample location being located in air on either side of the wall, for example, due to the relatively low density in those areas. The maximum density in the macrocell would also likely correspond to the density of the wall, such that the sample location has a high probability of being selected within a volume of the wall, if not near a surface of the wall.

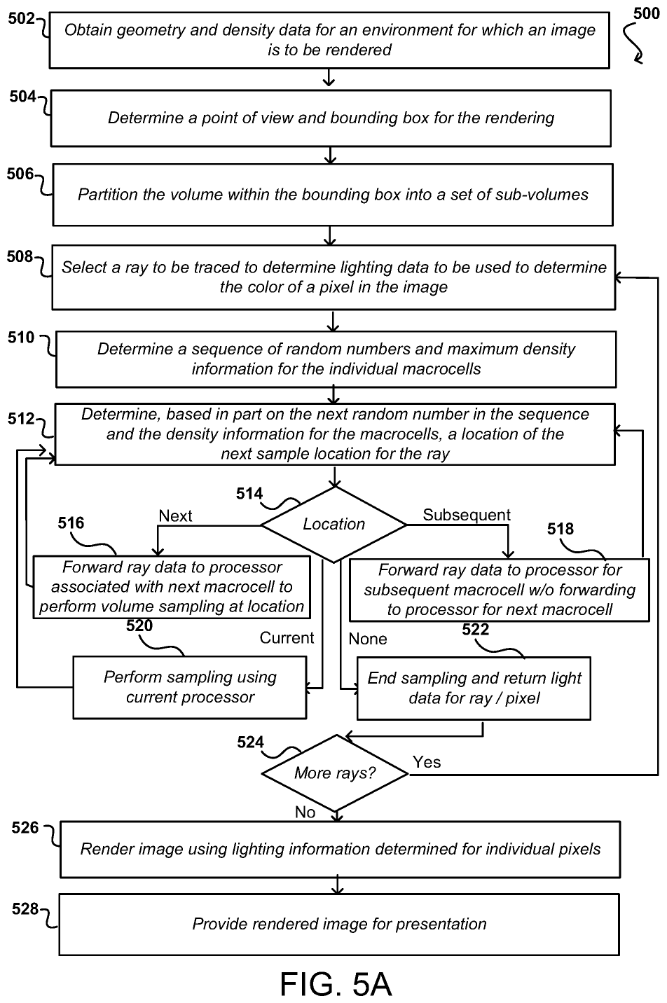

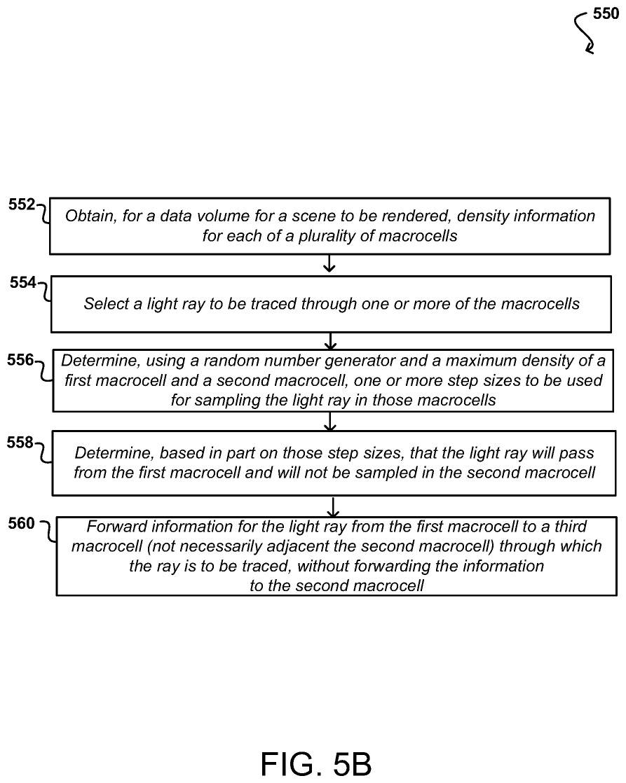

FIG. 5A illustrates an example process 500 for rendering an image that can be performed in accordance with at least one embodiment. It should be understood that for this and other processes presented herein that there may be additional, fewer, or alternative steps performed or similar or alternative orders, or at least partially in parallel, within the scope of the various embodiments unless otherwise specifically stated. Further, although this example is described with respect to point clouds and voxels, it should be understood that other types of data representations can be used as well within the scope of various embodiments. In this example process, data for a virtual environment—as may include geometry data and density data—can be obtained 502 for which an image is to be rendered. This may include, for example, data for a geometric mesh for any objects or surfaces in the environment, as well as density information for various locations or points in the environment, including for any objects in the environment. For an image to be rendered showing a view of the environment, a point of view can be determined 504 for the rendering (as may include or be based at least in part upon parameters for a virtual camera) as well as a bounding box indicating that portion or volume of the environment that should be processed for the image based, at least in part, upon the view. The bounding box may encompass the entire environment, in order to consider any possible light source in the environment that may impact at least one object in the field of view, or may encompass only a selected volume of the environment in order to reduce the amount of data to be processed, among other potential advantages. In this example, the bounding box can be partitioned 506 into a number of macrocells, which may be of equal or differing sizes and/or shapes, where the number of macrocells may be fixed or configurable.

In order to determine lighting information for each pixel of the image, one or more rays can be traced for each pixel to determine sources of light that impact that pixel. The ray(s) (or paths) to be traced can be determined based at least in part upon parameters of a virtual camera that determine the content to be represented at each pixel location. For a given pixel location, a ray can be selected 508 to be traced to determine lighting data to be used to determine the color of the respective pixel in the image. In this example, process, light sampling will be performed along the path of the ray instead of evaluating the ray at each potential location along the path, for reasons including at least some of those discussed elsewhere herein. In order to determine the sampling location(s), a sequence of random numbers can be determined 510, such as by using a random number generator, as well as maximum density for at least those individual macrocells through which the ray might, or is predicted to, pass. Based at least in part upon the selected random numbers and the density information, a location of each of the sample locations can be determined, and this determination can be made by a processor associated with any, or all, of the macrocells. A location of the next sample location to be processed can be determined 510 using this information, such as may involve sampling an exponential function of a probability distribution function, where regions of higher density—more likely to have an interaction with a light ray than a region of lower density—also have a higher probability of being selected as a sample position.

A determination 512 can be made 514 as to the macrocell in which the next sample location will be located. If the next sample point is the in the same macrocell as the prior sample point location, or if it is an initial sample point for the ray and is determined using the processor for that macrocell, then sampling for the ray at the next sample location can be performed 520 using the current processor, without needing to forward information for the ray to another processor responsible for a different macrocell. If it is determined that the next sample location is in the next macrocell through which the ray passes, then the data for the ray can be forwarded 516 to the processor associated with the next macrocell (unless the same processor is used for the current macrocell) whereby that processor can perform sampling for the next macrocell since that processor will store the data for at least that particular macrocell. If it is instead determined that the next sample point is not in the next macrocell along the path, but is instead in a subsequent macrocell along the path, then the ray data can be forwarded 518 to the processor storing data for that subsequent macrocell, without forwarding the ray data to the processor for the next macrocell along the path, or having the processor for the next macrocell perform any operations for the ray. By not involving the processor for the next macrocell that does not have any sample locations, the amount of bandwidth, data processing, and data storage or buffering in the system can be reduced, which can improve performance of the rendering system and conserve computing resources. This process can continue for each sample location determined along the ray based on the selected random numbers and density information. If it is determined that there are no more sample locations to be processed, then the sample process can end 522 for this ray, and light data for the ray (or the corresponding pixel) can be returned to be used for shading or other operations of the rendering process. If it is determined 524 that there are more rays to be cast, for the same or other pixels, then the process can continue. After (at least some of) the rays have been cast and light data determined, the image can be rendered 526 using the lighting information to determine the color values of the individual pixels of the image. The rendered image can then be provided 528 for presentation, either directly or after storage in a memory or storage medium.

In at least one embodiment, the step distances can correspond to delta or Woodcock steps that are determined from a probabilistic function. The process may include the use of two different random numbers for each sample location. As discussed with respect to FIG. 5A, the step sizes themselves, or sample locations, can be determined using a first set of random numbers along with the maximum density information for the various macrocells. An exponential function is sampled to determine a given step size. Once a sample location is selected based on the maximum density, the actual density value at that location can be determined. As mentioned, if the density at that location is similar, sufficiently close, or within a threshold value or percentage of the maximum density—such as at least about 80% or 90% of the maximum density—then that sample point can have a high probability of being accepted, otherwise the point may have a low probability of being accepted and may instead be rejected. For example, if a macrocell includes a wall as well as space on either side of the wall, then the sample location should ideally correspond to the wall in volume rendering, but will have some probability of the sample location being selected in the empty space on either side of the wall, which has a low probability of generating an interaction with the ray, and can therefore be rejected. This sampling of the actual value is a second accept or reject sampling process that can take into account, for example, the ratio of the volume density to the maximum density used for the macrocell. The second random number used in this second sampling process helps to indicate whether the particle at the sample point was completely transparent, such that the ray propagates without change, or if there was an interaction that can cause the ray to bounce, scatter, be absorbed, or otherwise change in path or intensity.

FIG. 5B illustrates an example process 550 that can be performed for an individual ray in accordance with at least one embodiment. In this example, density information can be obtained 552 for each of a plurality of macrocells for a data volume including data for a scene to be rendered, where that data can include at least geometry and density data. A light ray can be selected 554 to be traced through one or more of the volumes, where an initial location and direction of the ray can be determined based at least in part upon parameters of a virtual camera used to determine a view of the scene, as well as the location of a pixel of that image for which light or color information is to be determined. One or more step sizes to be used for sampling the light ray in those macrocells can be determined 556 by sampling an exponential or probabilistic function, such as may be based upon random numbers from a random number generator and a maximum density value for at least a first macrocell and a second macrocell through which the ray will pass. It can be determined 558 that, based in part upon those step sizes or the corresponding sample locations, that the light ray will pass from the first macrocell into the second macrocell, but will not be sampled in the second macrocell because there are no (or there is a low probability of any) sample locations for the ray in the second macrocell. Since there will be no processing (or a low probability of processing) of the ray to be performed in the second macrocell, information for the light ray can be forwarded 560 from the first macrocell (or a processor for the first macrocell) to a third macrocell (or processor for the third macrocell) for processing, where the third macrocell may or may not be the macrocell that the ray will pass through directly after the second macrocell (or is otherwise adjacent the second macrocell). The processor for the second macrocell will then not have to process any data for the ray in the second macrocell, and the second macrocell will not need to receive or process any information about this particular ray, which can conserve various compute-related resources.

Approaches discussed herein can also be used with primary ray generation in at least some embodiments. For example, it may be determined for a ray that passes through ten different macrocells that a first sample location is located in a third macrocell. Instead of processing the ray in the first macrocell and then forwarding to the third macrocell, further efficiencies can be obtained by instead starting the processing of the ray in the third macrocell. If the maximum density of the first and second macrocells is so low that there is a very low probability of the first sample location being in either of those macrocells, then ray tracing can start in the third macrocell using ray information such as the initial location and orientation of the ray. In some embodiments, the third macrocell can also predict that the first and second macrocells would not perform sampling for the ray, such that the third macrocell can take responsibility for initiating the tracing of the ray.

In at least one embodiment, approaches presented herein can be used with data parallel rendering, where a data set is rendered whose constituent parts are stored across multiple different nodes, or ranks. This can include data parallel volume path tracing where the input data is (at least partially) a volume data set. This data set can be rendered through sampling, but can otherwise include all volume data types for which sampling is possible, including structured volumes, unstructured mesh data, AMR data, and the like. A rendering process can involve ray forwarding based data-parallel rendering, which is a sub-set of data parallel rendering techniques that works by repeatedly “forwarding” a ray between different nodes that have different pieces of the data that this ray requires. A delta tracking approach, such as Woodcock tracking, can be used that performs volume rendering (or volume path tracing) by repeatedly computing free-flight distances. Assuming a maximum density of the volume is known or determinable in a given region, the PDF of how far a random particle might travel through this volume before it interacts with one of the particles that forms this volume can be determined. Such an approach can be used for stochastic integration, shooting random particles and computing where and how they interact with this volume. An optimization technique that can be performed for Woodcock tracking is to compute “macrocells” (or k-d trees, or any other spatial data structure over the underlying volume) where each spatial region of that data structure stores the maximum volume density within that region. A ray traversing this volume can then traverse this data structure, and in each region compute the delta tracking as described above; if the sampled distance makes the particle travel beyond the boundaries of that macrocell is can skip the entire macrocell without even sampling the volume in that region.

As discussed, aspects of various approaches presented herein can be lightweight enough to execute on a device such as a client device, such as a personal computer or gaming console, in real time. Such processing can be performed on, or for, content that is generated on, or received by, that client device or received from an external source, such as streaming data or other content received over at least one network. In some instances, the processing and/or determination of this content may be performed by one of these other devices, systems, or entities, then provided to the client device (or another such recipient) for presentation or another such use.

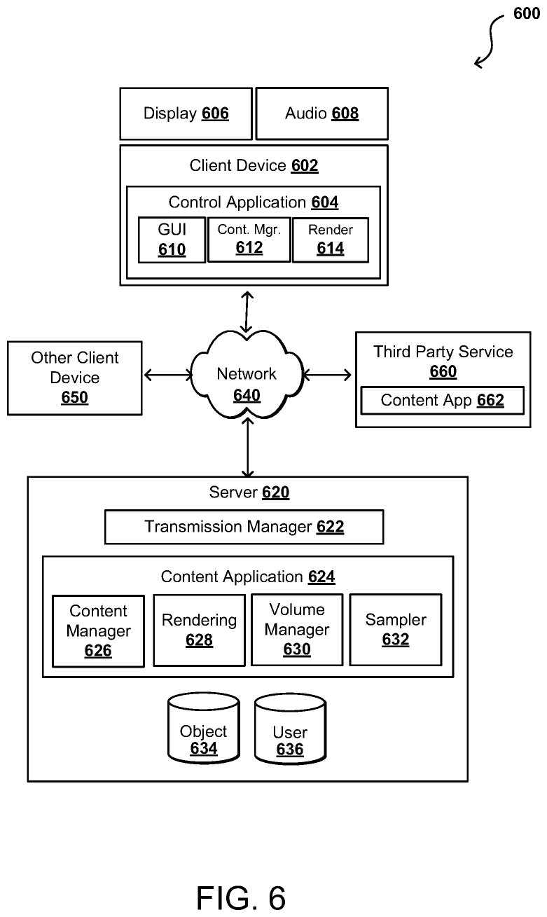

As an example, FIG. 6 illustrates an example networked system configuration 600 that can be used to provide, generate, modify, encode, process, and/or transmit image data or other such content. In at least one embodiment, a client device 602 can generate or receive data for a session using components of a control application 604 on client device 602 and data stored locally on that client device. In at least one embodiment, a content application 624 executing on a server 620—such as a cloud server or edge server—may initiate a session associated with at least one client device 602, as may use a session manager and user data stored in a user database 636, and can cause content such as one or more object representations—such as one or more geometric meshes with density information—from an object repository 634 to be selected by a content manager 626 for processing. A content manager 626 may work with a rendering module 628 to generate a digital representation of the selected object(s), such as may be used to render content to be provided for presentation via the client device 602. In at least one embodiment, this rendering module 628 can work with one or more volume manager(s) 630, which can determine a volume bounding box and macrocells for the rendering, and can ensure that processing resources are allocated for these macrocells. The rendering module 268 can also work with a sampler 632 which can determine sample locations in these macrocells and perform sampling at those locations. The light information obtained from the sampler 632 can be provided to the rendering module 628, which may use a shader or other such mechanism or process to use the light information to determine color values for various pixels of an image to be rendered. At least a portion of the generated content—which may correspond to a rendered image or data useful in generating a rendered image—may be transmitted to the client device 602 using an appropriate transmission manager 622 to send by download, streaming, or another such transmission channel. An encoder may be used to encode and/or compress at least some of this data before transmitting to the client device 602. In at least one embodiment, the client device 602 receiving such content can provide this content to a corresponding control application 604, which may also or alternatively include a graphical user interface (“GUI”) 610, content manager 612, and rendering module 614 for use in selecting, providing, rendering, modifying, or using content for presentation (or other purposes) on or by the client device 602. A decoder may also be used to decode data received over the network 640 for presentation via client device 602, such as image or video content through a display 606 and audio, such as sounds and music, through at least one audio playback device 608, such as speakers or headphones. In at least one embodiment, at least some of this content may already be stored on, rendered on, or accessible to client device 602 such that transmission over network 640 is not required for at least that portion of content, such as where that content may have been previously downloaded or stored locally on a hard drive or optical disk. In at least one embodiment, a transmission mechanism such as data streaming can be used to transfer this content from server 620, or user database 636, to client device 602. In at least one embodiment, at least a portion of this content can be obtained, enhanced, and/or streamed from another source, such as a third party service 660 or other client device 650, that may also include a content application 662 for generating, enhancing, or providing content. In at least one embodiment, portions of this functionality can be performed using multiple computing devices, or multiple processors within one or more computing devices, such as may include a combination of CPUs and GPUs.

In this example, these client devices can include any appropriate computing devices, as may include a desktop computer, notebook computer, set-top box, streaming device, gaming console, smartphone, tablet computer, VR headset, AR goggles, wearable computer, or a smart television. Each client device can submit a request across at least one wired or wireless network, as may include the Internet, an Ethernet, a local area network (“LAN”), or a cellular network, among other such options. In this example, these requests can be submitted to an address associated with a cloud provider, who may operate or control one or more electronic resources in a cloud provider environment, such as may include a data center or server farm. In at least one embodiment, the request may be received or processed by at least one edge server, that sits on a network edge and is outside at least one security layer associated with the cloud provider environment. In this way, latency can be reduced by enabling the client devices to interact with servers that are in closer proximity, while also improving security of resources in the cloud provider environment.

In at least one embodiment, such a system can be used for performing graphical rendering operations. In other embodiments, such a system can be used for other purposes, such as for providing image or video content to test or validate autonomous machine applications, or for performing deep learning operations. In at least one embodiment, such a system can be implemented using an edge device, or may incorporate one or more VMs. In at least one embodiment, such a system can be implemented at least partially in a data center or at least partially using cloud computing resources.

### Inference and Training Logic

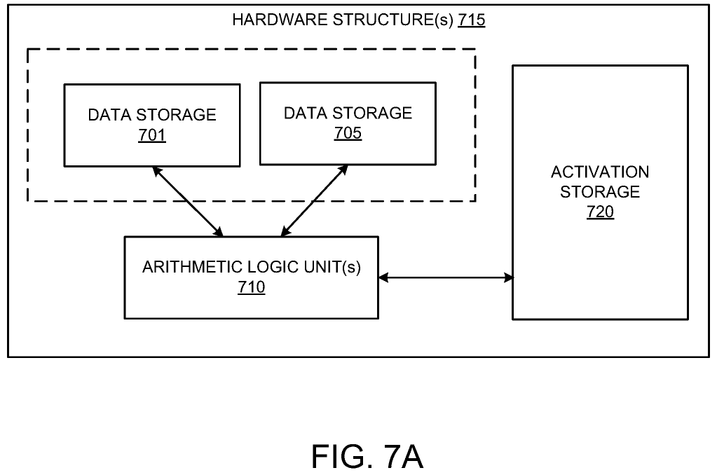

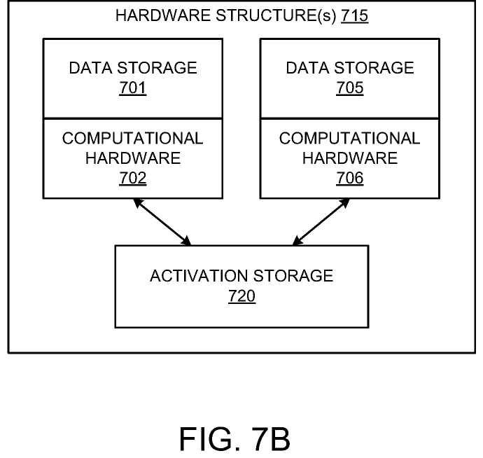

FIG. 7A illustrates inference and/or training logic 715 used to perform inferencing and/or training operations associated with one or more embodiments. Details regarding inference and/or training logic 715 are provided below in conjunction with FIGS. 7A and/or 7B.

In at least one embodiment, inference and/or training logic 715 may include, without limitation, code and/or data storage 701 to store forward and/or output weight and/or input/output data, and/or other parameters to configure neurons or layers of a neural network trained and/or used for inferencing in aspects of one or more embodiments. In at least one embodiment, training logic 715 may include, or be coupled to code and/or data storage 701 to store graph code or other software to control timing and/or order, in which weight and/or other parameter information is to be loaded to configure, logic, including integer and/or floating point units (collectively, arithmetic logic unit(s) (“ALU(s)”). In at least one embodiment, code, such as graph code, loads weight or other parameter information into processor ALU(s) based on an architecture of a neural network to which the code corresponds. In at least one embodiment, code and/or data storage 701 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 701 may be included with other on-chip or off-chip data storage, including a processor's L1, L2, or L3 cache or system memory.

In at least one embodiment, any portion of code and/or data storage 701 may be internal or external to one or more processors or other hardware logic devices or circuits. In at least one embodiment, code and/or data storage 701 may be cache memory, dynamic randomly addressable memory (“DRAM”), static randomly addressable memory (“SRAM”), non-volatile memory (for example, Flash memory), or other storage. In at least one embodiment, choice of whether code and/or data storage 701 is internal or external to a processor, for example, or comprised of DRAM, SRAM, Flash memory or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 may include, without limitation, a code and/or data storage 705 to store backward and/or output weight and/or input/output data corresponding to neurons or layers of a neural network trained and/or used for inferencing in aspects of one or more embodiments. In at least one embodiment, code and/or data storage 705 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 715 may include, or be coupled to code and/or data storage 705 to store graph code or other software to control timing and/or order, in which weight and/or other parameter information is to be loaded to configure, logic, including integer and/or floating point units (collectively, ALU(s). In at least one embodiment, code, such as graph code, loads weight or other parameter information into processor ALU(s) based on an architecture of a neural network to which the code corresponds. In at least one embodiment, any portion of code and/or data storage 705 may be included with other on-chip or off-chip data storage, including a processor's L1, L2, or L3 cache or system memory. In at least one embodiment, any portion of code and/or data storage 705 may be internal or external to on one or more processors or other hardware logic devices or circuits. In at least one embodiment, code and/or data storage 705 may be cache memory, DRAM, SRAM, non-volatile memory (for example, Flash memory), or other storage. In at least one embodiment, choice of whether code and/or data storage 705 is internal or external to a processor, for example, or comprised of DRAM, SRAM, Flash memory or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 701 and code and/or data storage 705 may be separate storage structures. In at least one embodiment, code and/or data storage 701 and code and/or data storage 705 may be same storage structure. In at least one embodiment, code and/or data storage 701 and code and/or data storage 705 may be partially same storage structure and partially separate storage structures. In at least one embodiment, any portion of code and/or data storage 701 and code and/or data storage 705 may be included with other on-chip or off-chip data storage, including a processor's L1, L2, or L3 cache or system memory.

In at least one embodiment, inference and/or training logic 715 may include, without limitation, one or more arithmetic logic unit(s) (“ALU(s)”) 710, including integer and/or floating point units, to perform logical and/or mathematical operations based, at least in part on, or indicated by, training and/or inference code (for example, graph code), a result of which may produce activations (for example, output values from layers or neurons within a neural network) stored in an activation storage 720 that are functions of input/output and/or weight parameter data stored in code and/or data storage 701 and/or code and/or data storage 705. In at least one embodiment, activations stored in activation storage 720 are generated according to linear algebraic and or matrix-based mathematics performed by ALU(s) 710 in response to performing instructions or other code, wherein weight values stored in code and/or data storage 701 and/or code and/or data storage 705 are used as operands along with other values, such as bias values, gradient information, momentum values, or other parameters or hyperparameters, any or all of which may be stored in code and/or data storage 701 or code and/or data storage 705 or another storage on or off-chip.

In at least one embodiment, ALU(s) 710 are included within one or more processors or other hardware logic devices or circuits, whereas in another embodiment, ALU(s) 710 may be external to a processor or other hardware logic device or circuit that uses them (for example, a co-processor). In at least one embodiment, ALU(s) 710 may be included within a processor's execution units or otherwise within a bank of ALU(s) accessible by a processor's execution units either within same processor or distributed between different processors of different types (for example, CPUs, GPUs, fixed function units, etc.). In at least one embodiment, code and/or data storage 701, code and/or data storage 705, and activation storage 720 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 720 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 720 may be cache memory, DRAM, SRAM, non-volatile memory (for example, Flash memory), or other storage. In at least one embodiment, activation storage 720 may be completely or partially within or external to one or more processors or other logical circuits. In at least one embodiment, choice of whether activation storage 720 is internal or external to a processor, for example, or comprised of DRAM, SRAM, Flash memory or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 715 illustrated in FIG. 7A may be used in conjunction with an application-specific integrated circuit (“ASIC”), such as Tensorflow® Processing Unit from Google, an inference processing unit (“IPU”) from Graphcore™, or a Nervana® (for example, “Lake Crest”) processor from Intel Corp. In at least one embodiment, inference and/or training logic 715 illustrated in FIG. 7A may be used in conjunction with CPU hardware, GPU hardware or other hardware, such as field programmable gate arrays (“FPGAs”).

FIG. 7B illustrates inference and/or training logic 715, according to at least one or more embodiments. In at least one embodiment, inference and/or training logic 715 may include, without limitation, hardware logic in which computational resources are dedicated or otherwise exclusively used in conjunction with weight values or other information corresponding to one or more layers of neurons within a neural network. In at least one embodiment, inference and/or training logic 715 illustrated in FIG. 7B may be used in conjunction with an ASIC, such as Tensorflow® Processing Unit from Google, an IPU from Graphcore™, or a Nervana® (for example, “Lake Crest”) processor from Intel Corp. In at least one embodiment, inference and/or training logic 715 illustrated in FIG. 7B may be used in conjunction with CPU hardware, GPU hardware or other hardware, such as FPGAs. In at least one embodiment, inference and/or training logic 715 includes, without limitation, code and/or data storage 701 and code and/or data storage 705, which may be used to store code (for example, graph code), weight values and/or other information, including bias values, gradient information, momentum values, and/or other parameter or hyperparameter information. In at least one embodiment illustrated in FIG. 7B, each of code and/or data storage 701 and code and/or data storage 705 is associated with a dedicated computational resource, such as computational hardware 702 and computational hardware 706, respectively. In at least one embodiment, each of computational hardware 702 and computational hardware 706 comprises one or more ALU(s) that perform mathematical functions, such as linear algebraic functions, only on information stored in code and/or data storage 701 and code and/or data storage 705, respectively, result of which is stored in activation storage 720.

In at least one embodiment, each of code and/or data storage 701 and 705 and corresponding computational hardware 702 and 706, respectively, correspond to different layers of a neural network, such that resulting activation from one “storage/computational pair 701/702” of code and/or data storage 701 and computational hardware 702 is provided as an input to “storage/computational pair 705/706” of code and/or data storage 705 and computational hardware 706, in order to mirror conceptual organization of a neural network. In at least one embodiment, each of storage/computational pairs 701/702 and 705/706 may correspond to more than one neural network layer. In at least one embodiment, additional storage/computation pairs (not shown) subsequent to or in parallel with storage computation pairs 701/702 and 705/706 may be included in inference and/or training logic 715.

### Data Center

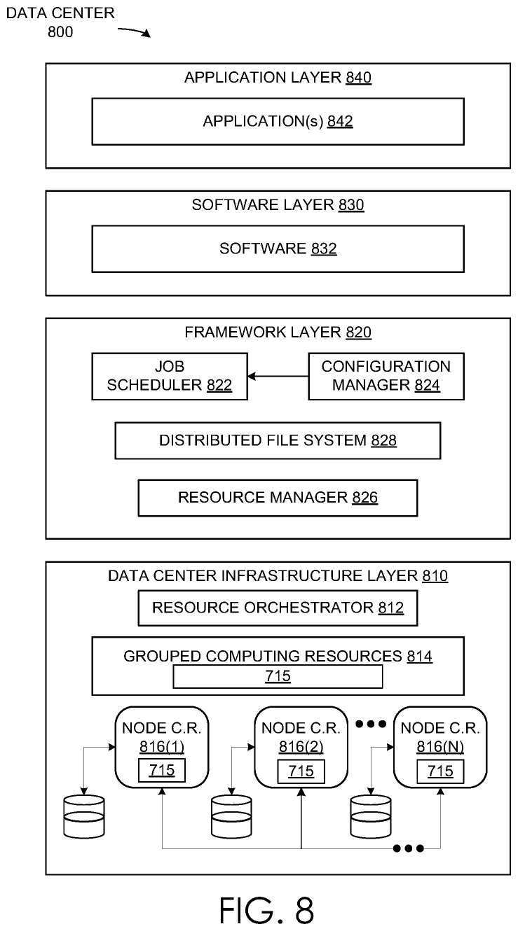

FIG. 8 illustrates an example data center 800, in which at least one embodiment may be used. In at least one embodiment, data center 800 includes a data center infrastructure layer 810, a framework layer 820, a software layer 830, and an application layer 840.

In at least one embodiment, as shown in FIG. 8, data center infrastructure layer 810 may include a resource orchestrator 812, grouped computing resources 814, and node computing resources (“node C.R.s”) 816(1)-816(N), where “N” represents any whole, positive integer. In at least one embodiment, node C.R.s 816(1)-816(N) may include, but are not limited to, any number of CPUs or other processors (including accelerators, FPGAs, graphics processors, etc.), memory devices (for example, dynamic read-only memory, storage devices (for example, solid state or disk drives), network input/output (“NW I/O”) devices, network switches, VMs, power modules, and cooling modules, etc. In at least one embodiment, one or more node C.R.s from among node C.R.s 816(1)-816(N) may be a server having one or more of above-mentioned computing resources.

In at least one embodiment, grouped computing resources 814 may include separate groupings of node C.R.s housed within one or more racks (not shown), or many racks housed in data centers at various geographical locations (also not shown). Separate groupings of node C.R.s within grouped computing resources 814 may include grouped compute, network, memory or storage resources that may be configured or allocated to support one or more workloads. In at least one embodiment, several node C.R.s including CPUs or processors may be grouped within one or more racks to provide compute resources to support one or more workloads. In at least one embodiment, one or more racks may also include any number of power modules, cooling modules, and network switches, in any combination.

In at least one embodiment, resource orchestrator 812 may configure or otherwise control one or more node C.R.s 816(1)-816(N) and/or grouped computing resources 814. In at least one embodiment, resource orchestrator 812 may include a software design infrastructure (“SDI”) management entity for data center 800. In at least one embodiment, resource orchestrator 812 may include hardware, software or some combination thereof.

In at least one embodiment, as shown in FIG. 8, framework layer 820 includes a job scheduler 822, a configuration manager 824, a resource manager 826, and a distributed file system 828. In at least one embodiment, framework layer 820 may include a framework to support software 832 of software layer 830 and/or one or more application(s) 842 of application layer 840. In at least one embodiment, software 832 or application(s) 842 may respectively include web-based service software or applications, such as those provided by Amazon Web Services, Google Cloud, and Microsoft Azure. In at least one embodiment, framework layer 820 may be, but is not limited to, a type of free and open-source software web application framework such as Apache Spark™ (hereinafter “Spark”) that may use distributed file system 828 for large-scale data processing (for example, “big data”). In at least one embodiment, job scheduler 822 may include a Spark driver to facilitate scheduling of workloads supported by various layers of data center 800. In at least one embodiment, configuration manager 824 may be capable of configuring different layers such as software layer 830 and framework layer 820 including Spark and distributed file system 828 for supporting large-scale data processing. In at least one embodiment, resource manager 826 may be capable of managing clustered or grouped computing resources mapped to or allocated for support of distributed file system 828 and job scheduler 822. In at least one embodiment, clustered or grouped computing resources may include grouped computing resource 814 at data center infrastructure layer 810. In at least one embodiment, resource manager 826 may coordinate with resource orchestrator 812 to manage these mapped or allocated computing resources.

In at least one embodiment, software 832 included in software layer 830 may include software used by at least portions of node C.R.s 816(1)-816(N), grouped computing resources 814, and/or distributed file system 828 of framework layer 820. The one or more types of software may include, but are not limited to, Internet web page search software, e-mail virus scan software, database software, and streaming video content software.

In at least one embodiment, application(s) 842 included in application layer 840 may include one or more types of applications used by at least portions of node C.R.s 816(1)-816(N), grouped computing resources 814, and/or distributed file system 828 of framework layer 820. One or more types of applications may include, but are not limited to, any number of a genomics application, a cognitive compute, and a machine learning application, including training or inferencing software, machine learning framework software (for example, PyTorch, TensorFlow, Caffe, etc.) or other machine learning applications used in conjunction with one or more embodiments.

In at least one embodiment, any of configuration manager 824, resource manager 826, and resource orchestrator 812 may implement any number and type of self-modifying actions based on any amount and type of data acquired in any technically feasible fashion. In at least one embodiment, self-modifying actions may relieve a data center operator of data center 800 from making possibly bad configuration decisions and possibly avoiding underused and/or poor performing portions of a data center.

In at least one embodiment, data center 800 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 800. In at least one embodiment, trained machine learning models corresponding to one or more neural networks may be used to infer or predict information using resources described above with respect to data center 800 by using weight parameters calculated through one or more training techniques described herein.

In at least one embodiment, data center may use CPUs, ASICs, GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence (“AI”) services.

Inference and/or training logic 715 are used to perform inferencing and/or training operations associated with one or more embodiments. Details regarding inference and/or training logic 715 are provided below in conjunction with FIGS. 7A and/or 7B. In at least one embodiment, inference and/or training logic 715 may be used in system FIG. 8 for inferencing or predicting operations based, at least in part, on weight parameters calculated using neural network training operations, neural network functions and/or architectures, or neural network use cases described herein.

Such components can be used to determine processors to perform sampling for a traced ray or particle based in part upon the densities of macrocells through which that ray passes.

### Computer Systems

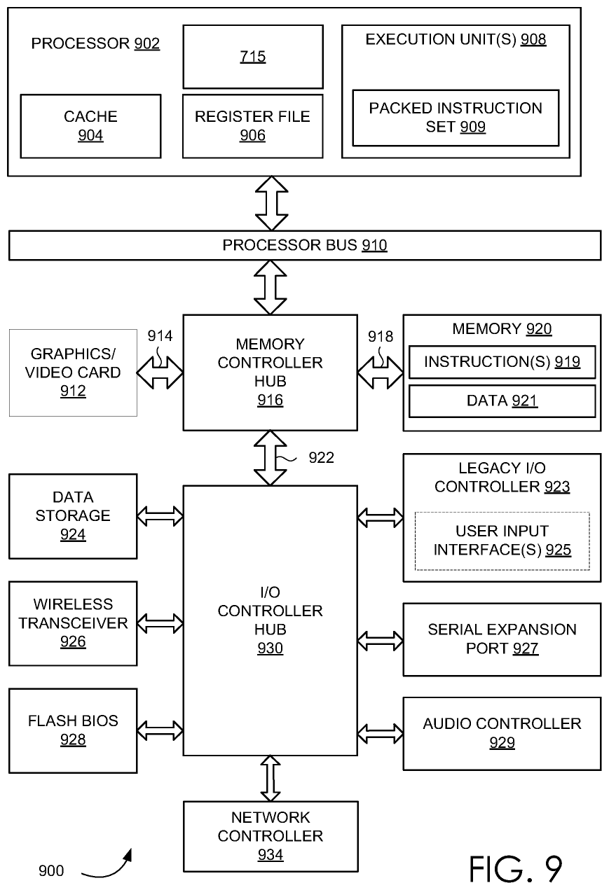

FIG. 9 is a block diagram illustrating an exemplary computer system, which may be a system with interconnected devices and components, a system-on-a-chip (“SOC”) or some combination thereof 900 formed with a processor that may include execution units to execute an instruction, according to at least one embodiment. In at least one embodiment, computer system 900 may include, without limitation, a component, such as a processor 902 to employ execution units including logic to perform algorithms for process data, in accordance with present disclosure, such as in embodiment described herein. In at least one embodiment, computer system 900 may include processors, such as PENTIUM® Processor family, Xeon™, Itanium®, XScale™ and/or StrongARM™, Intel® Core™, or Intel® Nervana™ microprocessors available from Intel Corporation of Santa Clara, Calif., although other systems (including PCs having other microprocessors, engineering workstations, set-top boxes and like) may also be used. In at least one embodiment, computer system 900 may execute a version of WINDOWS' operating system available from Microsoft Corporation of Redmond, Wash., although other operating systems (UNIX and Linux for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), SOC, network computers (“NetPCs”), set-top boxes, network hubs, wide area network (“WAN”) switches, or any other system that may perform one or more instructions in accordance with at least one embodiment.

In at least one embodiment, computer system 900 may include, without limitation, processor 902 that may include, without limitation, one or more execution unit(s) 908 to perform machine learning model training and/or inferencing according to techniques described herein. In at least one embodiment, computer system 900 is a single processor desktop or server system, but in another embodiment computer system 900 may be a multiprocessor system. In at least one embodiment, processor 902 may include, without limitation, a complex instruction set computing (“CISC”) microprocessor, a reduced instruction set computing (“RISC”) microprocessor, a very long instruction word computing (“VLIW”) microprocessor, a processor implementing a combination of instruction sets, or any other processor device, such as a DSP, for example. In at least one embodiment, processor 902 may be coupled to a processor bus 910 that may transmit data signals between processor 902 and other components in computer system 900.

In at least one embodiment, processor 902 may include, without limitation, a Level 1 (“L1”) internal cache memory (“cache”) 904. In at least one embodiment, processor 902 may have a single internal cache or multiple levels of internal cache. In at least one embodiment, cache 904 may reside external to processor 902. Other embodiments may also include a combination of both internal and external caches depending on particular implementation and needs. In at least one embodiment, register file 906 may store different types of data in various registers including, without limitation, integer registers, floating point registers, status registers, and instruction pointer register.

In at least one embodiment, execution unit(s) 908, including, without limitation, logic to perform integer and floating point operations, also resides in processor 902. In at least one embodiment, processor 902 may also include a microcode (“ucode”) read only memory (“ROM”) that stores microcode for certain macro instructions. In at least one embodiment, execution unit(s) 908 may include logic to handle a packed instruction set 909. In at least one embodiment, by including packed instruction set 909 in an instruction set of a general-purpose processor 902, along with associated circuitry to execute instructions, operations used by many multimedia applications may be performed using packed data in a general-purpose processor 902. In one or more embodiments, many multimedia applications may be accelerated and executed more efficiently by using full width of a processor data bus 910 for performing operations on packed data, which may eliminate need to transfer smaller units of data across processor data bus 910 to perform one or more operations one data element at a time.

In at least one embodiment, execution unit 908 may also be used in microcontrollers, embedded processors, graphics devices, DSPs, and other types of logic circuits. In at least one embodiment, computer system 900 may include, without limitation, a memory 920. In at least one embodiment, memory 920 may be implemented as a DRAM device, a SRAM device, flash memory device, or other memory device. In at least one embodiment, memory 920 may store instruction(s) 919 and/or data 921 represented by data signals that may be executed by processor 902.

In at least one embodiment, system logic chip may be coupled to processor bus 910 and memory 920. In at least one embodiment, system logic chip may include, without limitation, a memory controller hub (“MCH”) 916, and processor 902 may communicate with MCH 916 via processor bus 910. In at least one embodiment, MCH 916 may provide a high bandwidth memory path 918 to memory 920 for instruction and data storage and for storage of graphics commands, data and textures. In at least one embodiment, MCH 916 may direct data signals between processor 902, memory 920, and other components in computer system 900 and to bridge data signals between processor bus 910, memory 920, and a system I/O 922. In at least one embodiment, system logic chip may provide a graphics port for coupling to a graphics controller. In at least one embodiment, MCH 916 may be coupled to memory 920 through a high bandwidth memory path 918 and graphics/video card 912 may be coupled to MCH 916 through an Accelerated Graphics Port (“AGP”) interconnect 914.

In at least one embodiment, computer system 900 may use system I/O 922 that is a proprietary hub interface bus to couple MCH 916 to I/O controller hub (“ICH”) 930. In at least one embodiment, ICH 930 may provide direct connections to some I/O devices via a local I/O bus. In at least one embodiment, local I/O bus may include, without limitation, a high-speed I/O bus for connecting peripherals to memory 920, chipset, and processor 902. Examples may include, without limitation, an audio controller 929, a firmware hub (“flash BIOS”) 928, a wireless transceiver 926, a data storage 924, a legacy I/O controller 923 containing user input and keyboard interface(s) 925, a serial expansion port 927, such as Universal Serial Bus (“USB”), and a network controller 934. Data storage 924 may comprise a hard disk drive, a floppy disk drive, a CD-ROM device, a flash memory device, or other mass storage device.

In at least one embodiment, FIG. 9 illustrates a system, which includes interconnected hardware devices or “chips”, whereas in other embodiments, FIG. 9 may illustrate an exemplary SOC. In at least one embodiment, devices may be interconnected with proprietary interconnects, standardized interconnects (for example, PCIe) or some combination thereof. In at least one embodiment, one or more components of computer system 900 are interconnected using compute express link (“CXL”) interconnects.

Inference and/or training logic 715 are used to perform inferencing and/or training operations associated with one or more embodiments. Details regarding inference and/or training logic 715 are provided below in conjunction with FIGS. 7A and/or 7B. In at least one embodiment, inference and/or training logic 715 may be used in system FIG. 9 for inferencing or predicting operations based, at least in part, on weight parameters calculated using neural network training operations, neural network functions and/or architectures, or neural network use cases described herein.

Such components can be used to determine processors to perform sampling for a traced ray or particle based in part upon the densities of macrocells through which that ray passes.

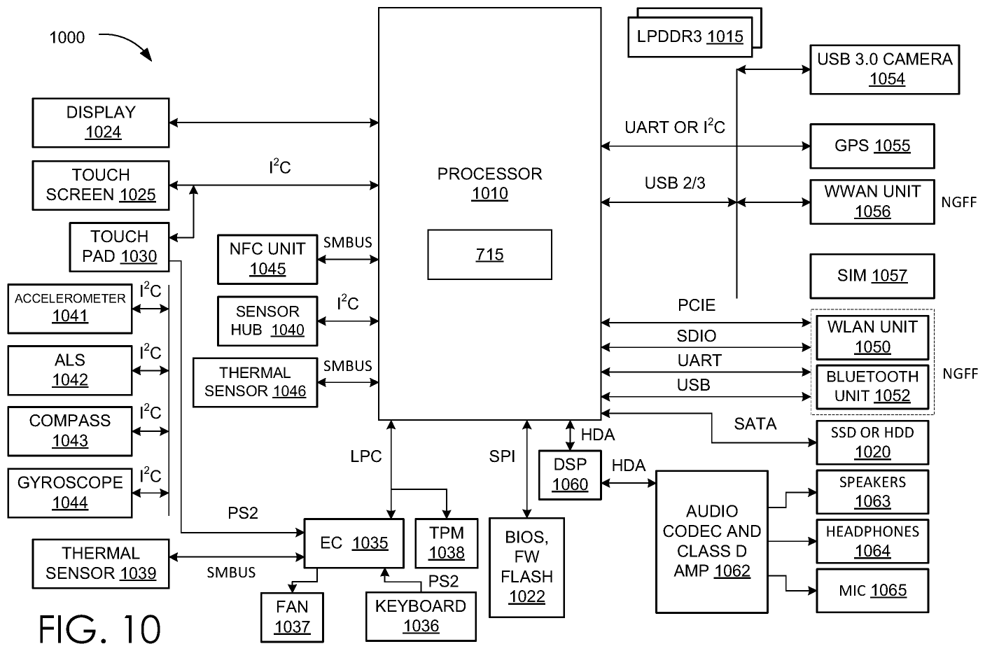

FIG. 10 is a block diagram illustrating an electronic device 1000 for using a processor 1010, according to at least one embodiment. In at least one embodiment, electronic device 1000 may be, for example and without limitation, a notebook, a tower server, a rack server, a blade server, a laptop, a desktop, a tablet, a mobile device, a phone, an embedded computer, or any other suitable electronic device.

In at least one embodiment, electronic device 1000 may include, without limitation, processor 1010 communicatively coupled to any suitable number or kind of components, peripherals, modules, or devices. In at least one embodiment, processor 1010 coupled using a bus or interface, such as a 1° C. bus, a System Management Bus (“SMBus”), a Low Pin Count (LPC) bus, a Serial Peripheral Interface (“SPI”), a High Definition Audio (“HDA”) bus, a Serial Advance Technology Attachment (“SATA”) bus, an USB (versions 1, 2, 3), or an Universal Asynchronous Receiver/Transmitter (“UART”) bus. In at least one embodiment, FIG. 10 illustrates an electronic device 1000, which includes interconnected hardware devices or “chips”, whereas in other embodiments, FIG. 10 may illustrate an exemplary SOC. In at least one embodiment, devices illustrated in FIG. 10 may be interconnected with proprietary interconnects, standardized interconnects (for example, PCIe) or some combination thereof. In at least one embodiment, one or more components of FIG. 10 are interconnected using CXL interconnects.

In at least one embodiment, FIG. 10 may include a display 1024, a touch screen 1025, a touch pad 1030, a Near Field Communications (“NFC”) unit 1045, a sensor hub 1040, a thermal sensor 1046, an Express Chipset (“EC”) 1035, a Trusted Platform Module (“TPM”) 1038, BIOS/firmware/flash memory (“BIOS, FW Flash”) 1022, a DSP 1060, a drive 1020 such as a Solid State Disk (“SSD”) or a Hard Disk Drive (“HDD”), a wireless local area network (“WLAN”) unit 1050, a Bluetooth unit 1052, a Wireless Wide Area Network (“WWAN”) unit 1056, a Global Positioning System (“GPS”) 1055, a camera (“USB 3.0 camera”) 1054 such as an USB 3.0 camera, and/or a Low Power Double Data Rate (“LPDDR”) memory unit (“LPDDR3”) 1015 implemented in, for example, LPDDR3 standard. These components may each be implemented in any suitable manner.

In at least one embodiment, other components may be communicatively coupled to processor 1010 through components discussed above. In at least one embodiment, an accelerometer 1041, Ambient Light Sensor (“ALS”) 1042, compass 1043, and a gyroscope 1044 may be communicatively coupled to sensor hub 1040. In at least one embodiment, thermal sensor 1039, a fan 1037, a keyboard 1036, and a touch pad 1030 may be communicatively coupled to EC 1035. In at least one embodiment, speakers 1063, headphones 1064, and microphone (“mic”) 1065 may be communicatively coupled to an audio unit (“audio codec and class d amp”) 1062, which may in turn be communicatively coupled to DSP 1060. In at least one embodiment, audio unit 1062 may include, for example and without limitation, an audio coder/decoder (“codec”) and a class D amplifier. In at least one embodiment, SIM card (“SIM”) 1057 may be communicatively coupled to WWAN unit 1056. In at least one embodiment, components such as WLAN unit 1050 and Bluetooth unit 1052, as well as WWAN unit 1056 may be implemented in a Next Generation Form Factor (“NGFF”).

Inference and/or training logic 715 are used to perform inferencing and/or training operations associated with one or more embodiments. Details regarding inference and/or training logic 715 are provided below in conjunction with FIGS. 7A and/or 7B. In at least one embodiment, inference and/or training logic 715 may be used in system FIG. 10 for inferencing or predicting operations based, at least in part, on weight parameters calculated using neural network training operations, neural network functions and/or architectures, or neural network use cases described herein.

Such components can be used to determine processors to perform sampling for a traced ray or particle based in part upon the densities of macrocells through which that ray passes.

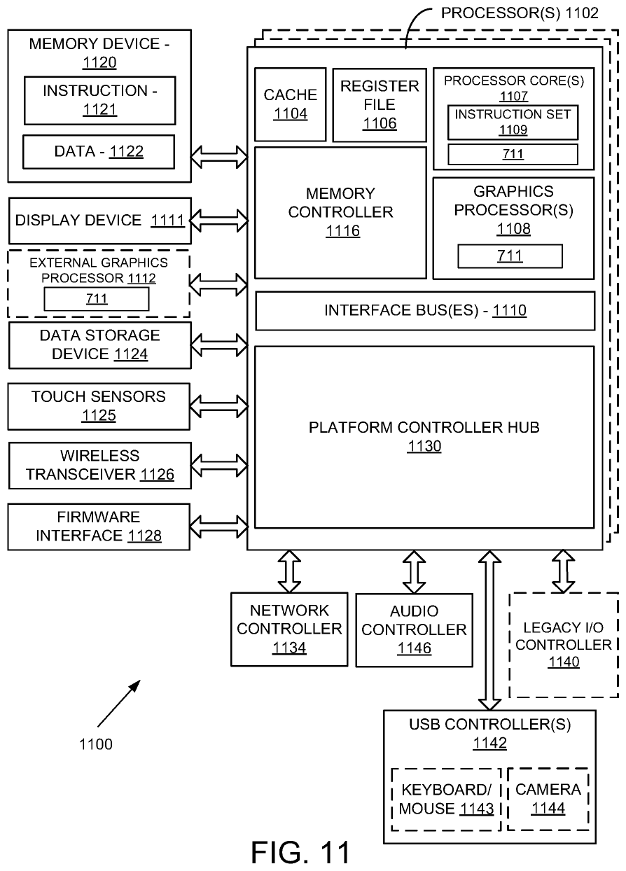

FIG. 11 is a block diagram of a processing system, according to at least one embodiment. In at least one embodiment, system 1100 includes one or more processor(s) 1102 and one or more graphics processor(s) 1108, and may be a single processor desktop system, a multiprocessor workstation system, or a server system having a large number of processor(s) 1102 or processor core(s) 1107. In at least one embodiment, system 1100 is a processing platform incorporated within a SoC integrated circuit for use in mobile, handheld, or embedded devices.

In at least one embodiment, system 1100 can include, or be incorporated within a server-based gaming platform, a game console, including a game and media console, a mobile gaming console, a handheld game console, or an online game console. In at least one embodiment, system 1100 is a mobile phone, smart phone, tablet computing device or mobile Internet device. In at least one embodiment, processing system 1100 can also include, coupled with, or be integrated within a wearable device, such as a smart watch wearable device, smart eyewear device, AR device, or VR device. In at least one embodiment, processing system 1100 is a television or set top box device having one or more processor(s) 1102 and a graphical interface generated by one or more graphics processor(s) 1108.

In at least one embodiment, one or more processor(s) 1102 each include one or more processor core(s) 1107 to process instructions which, when executed, perform operations for system and user software. In at least one embodiment, each of one or more processor core(s) 1107 is configured to process a specific instruction set 1109. In at least one embodiment, instruction set 1109 may facilitate CISC, RISC, or computing via a VLIW. In at least one embodiment, processor core(s) 1107 may each process a different instruction set 1109, which may include instructions to facilitate emulation of other instruction sets. In at least one embodiment, processor core(s) 1107 may also include other processing devices, such a DSP.

In at least one embodiment, processor(s) 1102 includes cache memory (“cache”) 1104. In at least one embodiment, processor(s) 1102 can have a single internal cache or multiple levels of internal cache. In at least one embodiment, cache memory is shared among various components of processor(s) 1102. In at least one embodiment, processor(s) 1102 also uses an external cache (for example, a Level-3 (“L3”) cache or Last Level Cache (“LLC”)) (not shown), which may be shared among processor core(s) 1107 using known cache coherency techniques. In at least one embodiment, register file 1106 is additionally included in processor(s) 1102 which may include different types of registers for storing different types of data (for example, integer registers, floating point registers, status registers, and an instruction pointer register). In at least one embodiment, register file 1106 may include general-purpose registers or other registers.

In at least one embodiment, one or more processor(s) 1102 are coupled with one or more interface bus(es) 1110 to transmit communication signals such as address, data, or control signals between processor(s) 1102 and other components in system 1100. In at least one embodiment, interface bus(es) 1110, in one embodiment, can be a processor bus, such as a version of a Direct Media Interface (“DMI”) bus. In at least one embodiment, interface bus(es) 1110 is not limited to a DMI bus, and may include one or more Peripheral Component Interconnect buses (for example, PCI, PCI Express), memory buses, or other types of interface buses. In at least one embodiment processor(s) 1102 include an integrated memory controller 1116 and a platform controller hub (“PCH”) 1130. In at least one embodiment, memory controller 1116 facilitates communication between a memory device 1120 and other components of system 1100, while PCH 1130 provides connections to I/O devices via a local I/O bus.

In at least one embodiment, memory device 1120 can be a DRAM device, a SRAM device, a flash memory device, a phase-change memory device, or some other memory device having suitable performance to serve as process memory. In at least one embodiment memory device 1120 can operate as system memory for system 1100, to store data 1122 and instruction 1121 for use when one or more processor(s) 1102 executes an application or process. In at least one embodiment, memory controller 1116 also couples with an optional external graphics processor 1112, which may communicate with one or more graphics processor(s) 1108 in processor(s) 1102 to perform graphics and media operations. In at least one embodiment, a display device 1111 can connect to processor(s) 1102. In at least one embodiment display device 1111 can include one or more of an internal display device, as in a mobile electronic device or a laptop device or an external display device attached via a display interface (for example, DisplayPort, etc.). In at least one embodiment, display device 1111 can include a head mounted display (“HMD”) such as a stereoscopic display device for use in VR applications or AR applications.

In at least one embodiment, PCH 1130 allows peripherals to connect to memory device 1120 and processor(s) 1102 via a high-speed I/O bus. In at least one embodiment, I/O peripherals include, but are not limited to, an audio controller 1146, a network controller 1134, a firmware interface 1128, a wireless transceiver 1126, touch sensors 1125, a data storage device 1124 (for example, a hard disk drive, a flash memory, etc.). In at least one embodiment, data storage device 1124 can connect via a storage interface (for example, SATA) or via a peripheral bus, such as a Peripheral Component Interconnect bus (for example, PCI, PCI Express). In at least one embodiment, touch sensors 1125 can include touch screen sensors, pressure sensors, or fingerprint sensors. In at least one embodiment, wireless transceiver 1126 can be a Wi-Fi transceiver, a Bluetooth transceiver, or a mobile network transceiver such as a 3G, 4G, or Long Term Evolution (“LTE”) transceiver. In at least one embodiment, firmware interface 1128 allows communication with system firmware, and can be, for example, a unified extensible firmware interface (“UEFI”). In at least one embodiment, network controller 1134 can allow a network connection to a wired network. In at least one embodiment, a high-performance network controller (not shown) couples with interface bus(es) 1110. In at least one embodiment, audio controller 1146 is a multi-channel high definition audio controller. In at least one embodiment, system 1100 includes an optional legacy I/O controller 1140 for coupling legacy (for example, Personal System 2 (“PS/2”)) devices to system. In at least one embodiment, PCH 1130 can also connect to one or more USB controllers 1142 connect input devices, such as keyboard and mouse 1143 combinations, a camera 1144, or other USB input devices.

In at least one embodiment, an instance of memory controller 1116 and PCH 1130 may be integrated into a discreet external graphics processor, such as external graphics processor 1112. In at least one embodiment, PCH 1130 and/or memory controller 1116 may be external to one or more processor(s) 1102. For example, in at least one embodiment, system 1100 can include an external memory controller 1116 and PCH 1130, which may be configured as a MCH and peripheral controller hub within a system chipset that is in communication with processor(s) 1102.

Inference and/or training logic 715 are used to perform inferencing and/or training operations associated with one or more embodiments. Details regarding inference and/or training logic 715 are provided below in conjunction with FIGS. 7A and/or 7B. In at least one embodiment portions or all of inference and/or training logic 715 may be incorporated into graphics processor 1500. For example, in at least one embodiment, training and/or inferencing techniques described herein may use one or more of ALU(s) embodied in a graphics processor. Moreover, in at least one embodiment, inferencing and/or training operations described herein may be done using logic other than logic illustrated in FIGS. 7A and/or 7B. In at least one embodiment, weight parameters may be stored in on-chip or off-chip memory and/or registers (shown or not shown) that configure ALU(s) of a graphics processor to perform one or more machine learning algorithms, neural network architectures, use cases, or training techniques described herein.

Such components can be used to determine processors to perform sampling for a traced ray or particle based in part upon the densities of macrocells through which that ray passes.

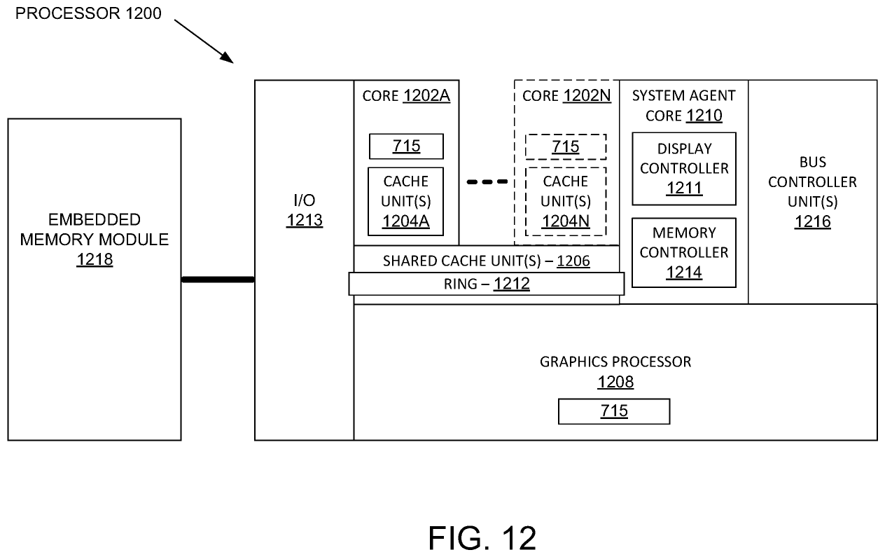

FIG. 12 is a block diagram of a processor 1200 having one or more processor core(s) 1202A-1202N, an integrated memory controller 1214, and an integrated graphics processor 1208, according to at least one embodiment. In at least one embodiment, processor 1200 can include additional cores up to and including additional core 1202N represented by dashed lined boxes. In at least one embodiment, each of processor core(s) 1202A-1202N includes one or more internal cache unit(s) 1204A-1204N. In at least one embodiment, each processor core also has access to one or more shared cached unit(s) 1206.

In at least one embodiment, internal cache unit(s) 1204A-1204N and shared cache unit(s) 1206 represent a cache memory hierarchy within processor 1200. In at least one embodiment, cache memory unit(s) 1204A-1204N may include at least one level of instruction and data cache within each processor core and one or more levels of shared mid-level cache, such as a Level 2 (L2), Level 3 (L3), Level 4 (L4), or other levels of cache, where a highest level of cache before external memory is classified as an LLC. In at least one embodiment, cache coherency logic maintains coherency between various cache unit(s) 1206 and 1204A-1204N.

In at least one embodiment, processor 1200 may also include a set of one or more bus controller unit(s) 1216 and a system agent core 1210. In at least one embodiment, one or more bus controller unit(s) 1216 manage a set of peripheral buses, such as one or more PCI or PCI express buses. In at least one embodiment, system agent core 1210 provides management functionality for various processor components. In at least one embodiment, system agent core 1210 includes one or more integrated memory controller(s) 1214 to manage access to various external memory devices (not shown).

In at least one embodiment, one or more of processor core(s) 1202A-1202N include support for simultaneous multi-threading. In at least one embodiment, system agent core 1210 includes components for coordinating and processor core(s) 1202A-1202N during multi-threaded processing. In at least one embodiment, system agent core 1210 may additionally include a power control unit (“PCU”), which includes logic and components to regulate one or more power states of processor core(s) 1202A-1202N and graphics processor 1208.

In at least one embodiment, processor 1200 additionally includes graphics processor 1208 to execute graphics processing operations. In at least one embodiment, graphics processor 1208 couples with shared cache unit(s) 1206, and system agent core 1210, including one or more integrated memory controller(s) 1214. In at least one embodiment, system agent core 1210 also includes a display controller 1211 to drive graphics processor output to one or more coupled displays. In at least one embodiment, display controller 1211 may also be a separate module coupled with graphics processor 1208 via at least one interconnect, or may be integrated within graphics processor 1208.

In at least one embodiment, a ring based interconnect unit 1212 is used to couple internal components of processor 1200. In at least one embodiment, an alternative interconnect unit may be used, such as a point-to-point interconnect, a switched interconnect, or other techniques. In at least one embodiment, graphics processor 1208 couples with ring based interconnect unit 1212 via an I/O link 1213.

In at least one embodiment, I/O link 1213 represents at least one of multiple varieties of I/O interconnects, including an on package I/O interconnect which facilitates communication between various processor components and a high-performance embedded memory module 1218, such as an eDRAM module. In at least one embodiment, each of processor core(s) 1202A-1202N and graphics processor 1208 use embedded memory module 1218 as a shared Last Level Cache.

In at least one embodiment, processor core(s) 1202A-1202N are homogenous cores executing a common instruction set architecture. In at least one embodiment, processor core(s) 1202A-1202N are heterogeneous in terms of instruction set architecture (“ISA”), where one or more of processor core(s) 1202A-1202N execute a common instruction set, while one or more other cores of processor core(s) 1202A-1202N executes a subset of a common instruction set or a different instruction set. In at least one embodiment, processor core(s) 1202A-1202N are heterogeneous in terms of microarchitecture, where one or more cores having a relatively higher power consumption couple with one or more power cores having a lower power consumption. In at least one embodiment, processor 1200 can be implemented on one or more chips or as a SOC integrated circuit.

Inference and/or training logic 715 are used to perform inferencing and/or training operations associated with one or more embodiments. Details regarding inference and/or training logic 715 are provided below in conjunction with FIGS. 7A and/or 7B. In at least one embodiment portions or all of inference and/or training logic 715 may be incorporated into processor 1200. For example, in at least one embodiment, training and/or inferencing techniques described herein may use one or more of ALU(s) embodied in graphics processor 1208, graphics core(s) 1202A-1202N, or other components in FIG. 12. Moreover, in at least one embodiment, inferencing and/or training operations described herein may be done using logic other than logic illustrated in FIGS. 7A and/or 7B. In at least one embodiment, weight parameters may be stored in on-chip or off-chip memory and/or registers (shown or not shown) that configure ALU(s) of graphics processor 1200 to perform one or more machine learning algorithms, neural network architectures, use cases, or training techniques described herein.

Such components can be used to determine processors to perform sampling for a traced ray or particle based in part upon the densities of macrocells through which that ray passes.

### Virtualized Computing Platform

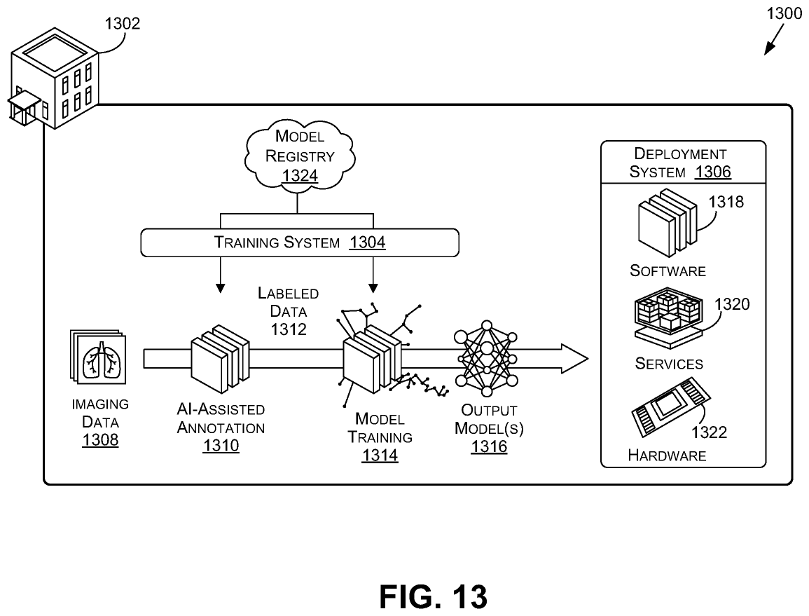

FIG. 13 is an example data flow diagram for a process 1300 of generating and deploying an image processing and inferencing pipeline, in accordance with at least one embodiment. In at least one embodiment, process 1300 may be deployed for use with imaging devices, processing devices, and/or other device types at one or more facility(ies) 1302. Process 1300 may be executed within a training system 1304 and/or a deployment system 1306. In at least one embodiment, training system 1304 may be used to perform training, deployment, and implementation of machine learning models (for example, neural networks, object detection algorithms, computer vision algorithms, etc.) for use in deployment system 1306. In at least one embodiment, deployment system 1306 may be configured to offload processing and compute resources among a distributed computing environment to reduce infrastructure requirements at facility(ies) 1302. In at least one embodiment, one or more applications in a pipeline may use or call upon services (for example, inference, visualization, compute, AI, etc.) of deployment system 1306 during execution of applications.

In at least one embodiment, some of applications used in advanced processing and inferencing pipelines may use machine learning models or other AI to perform one or more processing steps. In at least one embodiment, machine learning models may be trained at facility(ies) 1302 using data 1308 (such as imaging data) generated at facility(ies) 1302 (and stored on one or more picture archiving and communication system (“PACS”) servers at facility(ies) 1302), may be trained using imaging or sequencing data 1308 from another facility(ies) 1302, or a combination thereof. In at least one embodiment, training system 1304 may be used to provide applications, services, and/or other resources for generating working, deployable machine learning models for deployment system 1306.

In at least one embodiment, model registry 1324 may be backed by object storage that may support versioning and object metadata. In at least one embodiment, object storage may be accessible through, for example, a cloud storage compatible application programming interface (“API”) from within a cloud platform. In at least one embodiment, machine learning models within model registry 1324 may uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, training pipeline 1304 (FIG. 13) may include a scenario where facility(ies) 1302 is training their own machine learning model, or has an existing machine learning model that needs to be optimized or updated. In at least one embodiment, imaging data 1308 generated by imaging device(s), sequencing devices, and/or other device types may be received. In at least one embodiment, once imaging data 1308 is received, AI-assisted annotation 1310 may be used to aid in generating annotations corresponding to imaging data 1308 to be used as ground truth data for a machine learning model. In at least one embodiment, AI-assisted annotation 1310 may include one or more machine learning models (for example, convolutional neural networks (“CNNs”)) that may be trained to generate annotations corresponding to certain types of imaging data 1308 (for example, from certain devices). In at least one embodiment, AI-assisted annotation 1310 may then be used directly, or may be adjusted or fine-tuned using an annotation tool to generate ground truth data. In at least one embodiment, AI-assisted annotation 1310, labeled data 1312, or a combination thereof may be used as ground truth data for training a machine learning model. In at least one embodiment, a trained machine learning model may be referred to as output model(s) 1316, and may be used by deployment system 1306, as described herein.

In at least one embodiment, a training pipeline may include a scenario where facility(ies) 1302 needs a machine learning model for use in performing one or more processing tasks for one or more applications in deployment system 1306, but facility(ies) 1302 may not currently have such a machine learning model (or may not have a model that is optimized, efficient, or effective for such purposes). In at least one embodiment, an existing machine learning model may be selected from a model registry 1324. In at least one embodiment, model registry 1324 may include machine learning models trained to perform a variety of different inference tasks on imaging data. In at least one embodiment, machine learning models in model registry 1324 may have been trained on imaging data from different facilities than facility(ies) 1302 (for example, facilities remotely located). In at least one embodiment, machine learning models may have been trained on imaging data from one location, two locations, or any number of locations. In at least one embodiment, when being trained on imaging data from a specific location, training may take place at that location, or at least in a manner that protects confidentiality of imaging data or restricts imaging data from being transferred off-premises. In at least one embodiment, once a model is trained—or partially trained—at one location, a machine learning model may be added to model registry 1324. In at least one embodiment, a machine learning model may then be retrained, or updated, at any number of other facilities, and a retrained or updated model may be made available in model registry 1324. In at least one embodiment, a machine learning model may then be selected from model registry 1324—and referred to as output model(s) 1316—and may be used in deployment system 1306 to perform one or more processing tasks for one or more applications of a deployment system.

In at least one embodiment, a scenario may include facility(ies) 1302 requiring a machine learning model for use in performing one or more processing tasks for one or more applications in deployment system 1306, but facility(ies) 1302 may not currently have such a machine learning model (or may not have a model that is optimized, efficient, or effective for such purposes). In at least one embodiment, a machine learning model selected from model registry 1324 may not be fine-tuned or optimized for imaging data 1308 generated at facility(ies) 1302 because of differences in populations, robustness of training data used to train a machine learning model, diversity in anomalies of training data, and/or other issues with training data. In at least one embodiment, AI-assisted annotation 1310 may be used to aid in generating annotations corresponding to imaging data 1308 to be used as ground truth data for retraining or updating a machine learning model. In at least one embodiment, labeled data 1312 may be used as ground truth data for training a machine learning model. In at least one embodiment, retraining or updating a machine learning model may be referred to as model training 1314. In at least one embodiment, model training 1314 (for example, AI-assisted annotation 1310, labeled clinic data 1312, or a combination thereof) may be used as ground truth data for retraining or updating a machine learning model. In at least one embodiment, a trained machine learning model may be referred to as output model(s) 1316, and may be used by deployment system 1306, as described herein.

In at least one embodiment, deployment system 1306 may include software 1318, services 1320, hardware 1322, and/or other components, features, and functionality. In at least one embodiment, deployment system 1306 may include a software “stack,” such that software 1318 may be built on top of services 1320 and may use services 1320 to perform some or all of processing tasks, and services 1320 and software 1318 may be built on top of hardware 1322 and use hardware 1322 to execute processing, storage, and/or other compute tasks of deployment system 1306. In at least one embodiment, software 1318 may include any number of different containers, where each container may execute an instantiation of an application. In at least one embodiment, each application may perform one or more processing tasks in an advanced processing and inferencing pipeline (for example, inferencing, object detection, feature detection, segmentation, image enhancement, calibration, etc.). In at least one embodiment, an advanced processing and inferencing pipeline may be defined based on selections of different containers that are desired or required for processing imaging data 1308, in addition to containers that receive and configure imaging data for use by each container and/or for use by facility(ies) 1302 after processing through a pipeline (for example, to convert outputs back to a usable data type). In at least one embodiment, a combination of containers within software 1318 (for example, that make up a pipeline) may be referred to as a virtual instrument (as described in more detail herein), and a virtual instrument may leverage services 1320 and hardware 1322 to execute some or all processing tasks of applications instantiated in containers.

In at least one embodiment, a data processing pipeline may receive input data (for example, imaging data 1308) in a specific format in response to an inference request (for example, a request from a user of deployment system 1306). In at least one embodiment, input data may be representative of one or more images, video, and/or other data representations generated by one or more imaging devices. In at least one embodiment, data may undergo pre-processing as part of data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (for example, as a response to an inference request). In at least one embodiment, inferencing tasks may be performed by one or more machine learning models, such as trained or deployed neural networks, which may include output model(s) 1316 of training system 1304.

In at least one embodiment, tasks of data processing pipeline may be encapsulated in a container(s) that each represents a discrete, fully functional instantiation of an application and virtualized computing environment that is able to reference machine learning models. In at least one embodiment, containers or applications may be published into a private (for example, limited access) area of a container registry (described in more detail herein), and trained or deployed models may be stored in model registry 1324 and associated with one or more applications. In at least one embodiment, images of applications (for example, container images) may be available in a container registry, and once selected by a user from a container registry for deployment in a pipeline, an image may be used to generate a container for an instantiation of an application for use by a user's system.

In at least one embodiment, developers (for example, software developers, clinicians, doctors, etc.) may develop, publish, and store applications (for example, as containers) for performing image processing and/or inferencing on supplied data. In at least one embodiment, development, publishing, and/or storing may be performed using a software development kit (“SDK”) associated with a system (for example, to ensure that an application and/or container developed is compliant with or compatible with a system). In at least one embodiment, an application that is developed may be tested locally (for example, at a first facility, on data from a first facility) with a SDK which may support at least some of services 1320 as a system (for example, system 1200 of FIG. 12). In at least one embodiment, because DICOM objects may contain anywhere from one to hundreds of images or other data types, and due to a variation in data, a developer may be responsible for managing (for example, setting constructs for, building pre-processing into an application, etc.) extraction and preparation of incoming data. In at least one embodiment, once validated by system 1300 (for example, for accuracy), an application may be available in a container registry for selection and/or implementation by a user to perform one or more processing tasks with respect to data at a facility (for example, a second facility) of a user.

In at least one embodiment, developers may then share applications or containers through a network for access and use by users of a system (for example, system 1300 of FIG. 13). In at least one embodiment, completed and validated applications or containers may be stored in a container registry and associated machine learning models may be stored in model registry 1324. In at least one embodiment, a requesting entity—who provides an inference or image processing request—may browse a container registry and/or model registry 1324 for an application, container, dataset, machine learning model, etc., select a desired combination of elements for inclusion in data processing pipeline, and submit an imaging processing request. In at least one embodiment, a request may include input data (and associated patient data, in some examples) that is necessary to perform a request, and/or may include a selection of application(s) and/or machine learning models to be executed in processing a request. In at least one embodiment, a request may then be passed to one or more components of deployment system 1306 (for example, a cloud) to perform processing of data processing pipeline. In at least one embodiment, processing by deployment system 1306 may include referencing selected elements (for example, applications, containers, models, etc.) from a container registry and/or model registry 1324. In at least one embodiment, once results are generated by a pipeline, results may be returned to a user for reference (for example, for viewing in a viewing application suite executing on a local, on-premises workstation or terminal).

In at least one embodiment, to aid in processing or execution of applications or containers in pipelines, services 1320 may be leveraged. In at least one embodiment, services 1320 may include compute services, AI services, visualization services, and/or other service types. In at least one embodiment, services 1320 may provide functionality that is common to one or more applications in software 1318, so functionality may be abstracted to a service that may be called upon or leveraged by applications. In at least one embodiment, functionality provided by services 1320 may run dynamically and more efficiently, while also scaling well by allowing applications to process data in parallel (for example, using a parallel computing platform). In at least one embodiment, rather than each application that shares a same functionality offered by services 1320 being required to have a respective instance of services 1320, services 1320 may be shared between and among various applications. In at least one embodiment, services 1320 may include an inference server or engine that may be used for executing detection or segmentation tasks, as non-limiting examples. In at least one embodiment, a model training service may be included that may provide machine learning model training and/or retraining capabilities. In at least one embodiment, a data augmentation service may further be included that may provide GPU accelerated data (for example, DICOM, RIS, CIS, REST compliant, RPC, raw, etc.) extraction, resizing, scaling, and/or other augmentation. In at least one embodiment, a visualization service may be used that may add image rendering effects—such as ray-tracing, rasterization, denoising, sharpening, etc.—to add realism to two-dimensional (“2D”) and/or 3D models. In at least one embodiment, virtual instrument services may be included that provide for beam-forming, segmentation, inferencing, imaging, and/or support for other applications within pipelines of virtual instruments.

In at least one embodiment, where services 1320 includes an AI service (for example, an inference service), one or more machine learning models may be executed by calling upon (for example, as an API call) an inference service (for example, an inference server) to execute machine learning model(s), or processing thereof, as part of application execution. In at least one embodiment, where another application includes one or more machine learning models for segmentation tasks, an application may call upon an inference service to execute machine learning models for performing one or more of processing operations associated with segmentation tasks. In at least one embodiment, software 1318 implementing advanced processing and inferencing pipeline that includes segmentation application and anomaly detection application may be streamlined because each application may call upon a same inference service to perform one or more inferencing tasks.

In at least one embodiment, hardware 1322 may include GPUs, CPUs, graphics cards, an AI/deep learning system (for example, an AI supercomputer, such as NVIDIA's DGX Systems), a cloud platform, or a combination thereof. In at least one embodiment, different types of hardware 1322 may be used to provide efficient, purpose-built support for software 1318 and services 1320 in deployment system 1306. In at least one embodiment, use of GPU processing may be implemented for processing locally (for example, at facility(ies) 1302), within an AI/deep learning system, in a cloud system, and/or in other processing components of deployment system 1306 to improve efficiency, accuracy, and efficacy of image processing and generation. In at least one embodiment, software 1318 and/or services 1320 may be optimized for GPU processing with respect to deep learning, machine learning, and/or high-performance computing, as non-limiting examples. In at least one embodiment, at least some of computing environment of deployment system 1306 and/or training system 1304 may be executed in a datacenter one or more supercomputers or high performance computing systems, with GPU optimized software (for example, hardware and software combination of NVIDIA's DGX Systems). In at least one embodiment, hardware 1322 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform (for example, NVIDIA's NGC) may be executed using an AI/deep learning supercomputer(s) and/or GPU-optimized software (for example, as provided on NVIDIA's DGX Systems) as a hardware abstraction and scaling platform. In at least one embodiment, cloud platform may integrate an application container clustering system or orchestration system (for example, KUBERNETES) on multiple GPUs to allow seamless scaling and load balancing.

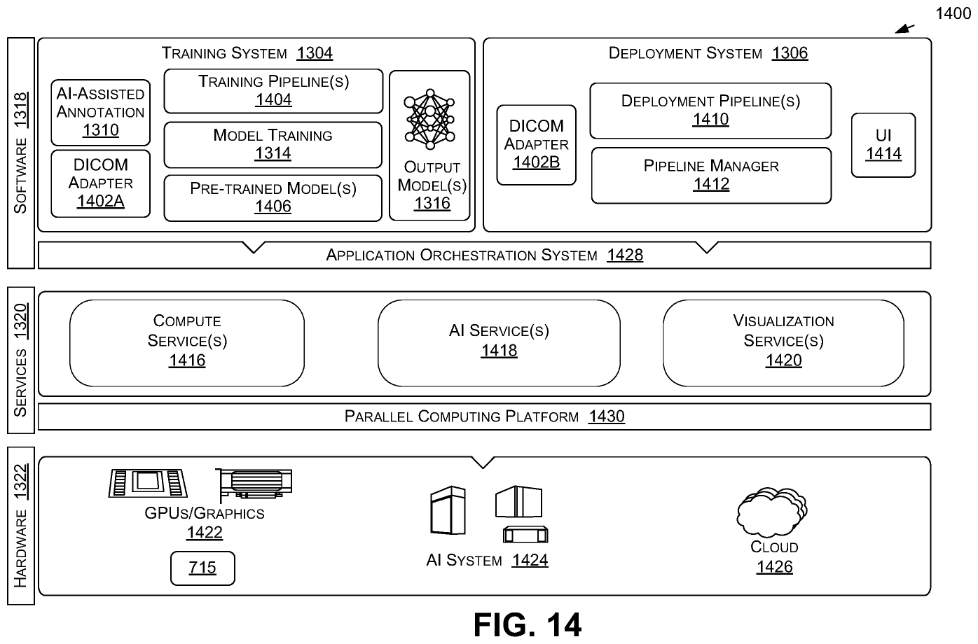

FIG. 14 is a system diagram for an example system 1400 for generating and deploying an imaging deployment pipeline, in accordance with at least one embodiment. In at least one embodiment, system 1400 may be used to implement process 1300 of FIG. 13 and/or other processes including advanced processing and inferencing pipelines. In at least one embodiment, system 1400 may include training system 1304 and deployment system 1306. In at least one embodiment, training system 1304 and deployment system 1306 may be implemented using software 1318, services 1320, and/or hardware 1322, as described herein.

In at least one embodiment, system 1400 (for example, training system 1304 and/or deployment system 1306) may implemented in a cloud computing environment (for example, using cloud 1426). In at least one embodiment, system 1400 may be implemented locally with respect to a healthcare services facility, or as a combination of both cloud and local computing resources. In at least one embodiment, access to APIs in cloud 1426 may be restricted to authorized users through enacted security measures or protocols. In at least one embodiment, a security protocol may include web tokens that may be signed by an authentication (for example, AuthN, AuthZ, Gluecon, etc.) service and may carry appropriate authorization. In at least one embodiment, APIs of virtual instruments (described herein), or other instantiations of system 1400, may be restricted to a set of public IPs that have been vetted or authorized for interaction.

In at least one embodiment, various components of system 1400 may communicate between and among one another using any of a variety of different network types, including but not limited to LANs and/or WANs via wired and/or wireless communication protocols. In at least one embodiment, communication between facilities and components of system 1400 (for example, for transmitting inference requests, for receiving results of inference requests, etc.) may be communicated over data bus(ses), wireless data protocols (Wi-Fi), wired data protocols (for example, Ethernet), etc.

In at least one embodiment, training system 1304 may execute training pipeline(s) 1404, similar to those described herein with respect to FIG. 13. In at least one embodiment, where one or more machine learning models are to be used in deployment pipeline(s) 1410 by deployment system 1306, training pipeline(s) 1404 may be used to train or retrain one or more (for example, pre-trained) models, and/or implement one or more of pre-trained model(s) 1406 (for example, without a need for retraining or updating). In at least one embodiment, as a result of training pipeline(s) 1404, output model(s) 1316 may be generated. In at least one embodiment, training pipeline(s) 1404 may include any number of processing steps, such as but not limited to imaging data (or other input data) conversion or adaption In at least one embodiment, for different machine learning models used by deployment system 1306, different training pipeline(s) 1404 may be used. In at least one embodiment, training pipeline(s) 1404 similar to a first example described with respect to FIG. 13 may be used for a first machine learning model, training pipeline(s) 1404 similar to a second example described with respect to FIG. 13 may be used for a second machine learning model, and training pipeline(s) 1404 similar to a third example described with respect to FIG. 13 may be used for a third machine learning model. In at least one embodiment, any combination of tasks within training system 1304 may be used depending on what is required for each respective machine learning model. In at least one embodiment, one or more of machine learning models may already be trained and ready for deployment so machine learning models may not undergo any processing by training system 1304, and may be implemented by deployment system 1306.

In at least one embodiment, output model(s) 1316 and/or pre-trained model(s) 1406 may include any types of machine learning models depending on implementation or embodiment. In at least one embodiment, and without limitation, machine learning models used by system 1400 may include machine learning model(s) using linear regression, logistic regression, decision trees, support vector machines (“SVM”), Naïve Bayes, k-nearest neighbor (“Knn”), K means clustering, random forest, dimensionality reduction algorithms, gradient boosting algorithms, neural networks (for example, auto-encoders, convolutional, recurrent, perceptrons, Long/Short Term Memory (“LSTM”), Hopfield, Boltzmann, deep belief, deconvolutional, generative adversarial, liquid state machine, etc.), and/or other types of machine learning models.

In at least one embodiment, training pipeline(s) 1404 may include AI-assisted annotation, as described in more detail herein with respect to at least FIG. 14. In at least one embodiment, labeled data 1312 (for example, traditional annotation) may be generated by any number of techniques. In at least one embodiment, labels or other annotations may be generated within a drawing program (for example, an annotation program), a computer aided design (“CAD”) program, a labeling program, another type of program suitable for generating annotations or labels for ground truth, and/or may be hand drawn, in some examples. In at least one embodiment, ground truth data may be synthetically produced (for example, generated from computer models or renderings), real produced (for example, designed and produced from real-world data), machine-automated (for example, using feature analysis and learning to extract features from data and then generate labels), human annotated (for example, labeler, or annotation expert, defines location of labels), and/or a combination thereof. In at least one embodiment, for each instance of imaging data 1308 (or other data type used by machine learning models), there may be corresponding ground truth data generated by training system 1304. In at least one embodiment, AI-assisted annotation 1310 may be performed as part of deployment pipeline(s) 1410; either in addition to, or in lieu of AI-assisted annotation 1310 included in training pipeline(s) 1404. In at least one embodiment, system 1400 may include a multi-layer platform that may include a software layer (for example, software 1318) of diagnostic applications (or other application types) that may perform one or more medical imaging and diagnostic functions. In at least one embodiment, system 1400 may be communicatively coupled to (for example, via encrypted links) PACS server networks of one or more facilities. In at least one embodiment, system 1400 may be configured to access and referenced data from PACS servers to perform operations, such as training machine learning models, deploying machine learning models, image processing, inferencing, and/or other operations.

In at least one embodiment, a software layer may be implemented as a secure, encrypted, and/or authenticated API through which applications or containers may be invoked (for example, called) from an external environment(s) (for example, facility 1302). In at least one embodiment, applications may then call or execute one or more services 1320 for performing compute, AI, or visualization tasks associated with respective applications, and software 1318 and/or services 1320 may leverage hardware 1322 to perform processing tasks in an effective and efficient manner. In at least one embodiment, communications sent to, or received by, a training system 1304 and a deployment system 1306 may occur using a pair of DICOM adapters 1402A, 1402B.

In at least one embodiment, deployment system 1306 may execute deployment pipeline(s) 1410. In at least one embodiment, deployment pipeline(s) 1410 may include any number of applications that may be sequentially, non-sequentially, or otherwise applied to imaging data (and/or other data types) generated by imaging devices, sequencing devices, genomics devices, etc.—including AI-assisted annotation, as described above. In at least one embodiment, as described herein, a deployment pipeline(s) 1410 for an individual device may be referred to as a virtual instrument for a device (for example, a virtual ultrasound instrument, a virtual CT scan instrument, a virtual sequencing instrument, etc.). In at least one embodiment, for a single device, there may be more than one deployment pipeline(s) 1410 depending on information desired from data generated by a device. In at least one embodiment, where detections of anomalies are desired from an MRI machine, there may be a first deployment pipeline(s) 1410, and where image enhancement is desired from output of an MM machine, there may be a second deployment pipeline(s) 1410.

In at least one embodiment, an image generation application may include a processing task that includes use of a machine learning model. In at least one embodiment, a user may desire to use their own machine learning model, or to select a machine learning model from model registry 1324. In at least one embodiment, a user may implement their own machine learning model or select a machine learning model for inclusion in an application for performing a processing task. In at least one embodiment, applications may be selectable and customizable, and by defining constructs of applications, deployment and implementation of applications for a particular user are presented as a more seamless user experience. In at least one embodiment, by leveraging other features of system 1400—such as services 1320 and hardware 1322—deployment pipeline(s) 1410 may be even more user friendly, provide for easier integration, and produce more accurate, efficient, and timely results.

In at least one embodiment, deployment system 1306 may include a user interface (“UI”) 1414 (for example, a graphical user interface, a web interface, etc.) that may be used to select applications for inclusion in deployment pipeline(s) 1410, arrange applications, modify or change applications or parameters or constructs thereof, use and interact with deployment pipeline(s) 1410 during set-up and/or deployment, and/or to otherwise interact with deployment system 1306. In at least one embodiment, although not illustrated with respect to training system 1304, UI 1414 (or a different user interface) may be used for selecting models for use in deployment system 1306, for selecting models for training, or retraining, in training system 1304, and/or for otherwise interacting with training system 1304.

In at least one embodiment, pipeline manager 1412 may be used, in addition to an application orchestration system 1428, to manage interaction between applications or containers of deployment pipeline(s) 1410 and services 1320 and/or hardware 1322. In at least one embodiment, pipeline manager 1412 may be configured to facilitate interactions from application to application, from application to services 1320, and/or from application or service to hardware 1322. In at least one embodiment, although illustrated as included in software 1318, this is not intended to be limiting, and in some examples pipeline manager 1412 may be included in services 1320. In at least one embodiment, application orchestration system 1428 (for example, Kubernetes, DOCKER, etc.) may include a container orchestration system that may group applications into containers as logical units for coordination, management, scaling, and deployment. In at least one embodiment, by associating applications from deployment pipeline(s) 1410 (for example, a reconstruction application, a segmentation application, etc.) with individual containers, each application may execute in a self-contained environment (for example, at a kernel level) to increase speed and efficiency.

In at least one embodiment, each application and/or container (or image thereof) may be individually developed, modified, and deployed (for example, a first user or developer may develop, modify, and deploy a first application and a second user or developer may develop, modify, and deploy a second application separate from a first user or developer), which may allow for focus on, and attention to, a task of a single application and/or container(s) without being hindered by tasks of another application(s) or container(s). In at least one embodiment, communication, and cooperation between different containers or applications may be aided by pipeline manager 1412 and application orchestration system 1428. In at least one embodiment, so long as an expected input and/or output of each container or application is known by a system (for example, based on constructs of applications or containers), application orchestration system 1428 and/or pipeline manager 1412 may facilitate communication among and between, and sharing of resources among and between, each of applications or containers. In at least one embodiment, because one or more of applications or containers in deployment pipeline(s) 1410 may share same services and resources, application orchestration system 1428 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, a scheduler may thus allocate resources to different applications and distribute resources between and among applications in view of requirements and availability of a system. In some examples, a scheduler (and/or other component of application orchestration system 1428) may determine resource availability and distribution based on constraints imposed on a system (for example, user constraints), such as quality of service (QoS), urgency of need for data outputs (for example, to determine whether to execute real-time processing or delayed processing), etc.

In at least one embodiment, services 1320 leveraged by and shared by applications or containers in deployment system 1306 may include compute service(s) 1416, AI service(s) 1418, visualization service(s) 1420, and/or other service types. In at least one embodiment, applications may call (for example, execute) one or more of services 1320 to perform processing operations for an application. In at least one embodiment, compute service(s) 1416 may be leveraged by applications to perform super-computing or other high-performance computing (HPC) tasks. In at least one embodiment, compute service(s) 1416 may be leveraged to perform parallel processing (for example, using a parallel computing platform 1430) for processing data through one or more of applications and/or one or more tasks of a single application, substantially simultaneously. In at least one embodiment, parallel computing platform 1430 (for example, NVIDIA's CUDA) may allow general purpose computing on GPUs (“GPGPU”) (for example, GPUs/Graphics 1422). In at least one embodiment, a software layer of parallel computing platform 1430 may provide access to virtual instruction sets and parallel computational elements of GPUs, for execution of compute kernels. In at least one embodiment, parallel computing platform 1430 may include memory and, in some embodiments, a memory may be shared between and among multiple containers, and/or between and among different processing tasks within a single container. In at least one embodiment, inter-process communication (IPC) calls may be generated for multiple containers and/or for multiple processes within a container to use same data from a shared segment of memory of parallel computing platform 1430 (for example, where multiple different stages of an application or multiple applications are processing same information). In at least one embodiment, rather than making a copy of data and moving data to different locations in memory (for example, a read/write operation), same data in same location of a memory may be used for any number of processing tasks (for example, at a same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI service(s) 1418 may be leveraged to perform inferencing services for executing machine learning model(s) associated with applications (for example, tasked with performing one or more processing tasks of an application). In at least one embodiment, AI service(s) 1418 may leverage AI system 1424 to execute machine learning model(s) (for example, neural networks, such as CNNs) for segmentation, reconstruction, object detection, feature detection, classification, and/or other inferencing tasks. In at least one embodiment, applications of deployment pipeline(s) 1410 may use one or more of output model(s) 1316 from training system 1304 and/or other models of applications to perform inference on imaging data. In at least one embodiment, two or more examples of inferencing using application orchestration system 1428 (for example, a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 1428 may distribute resources (for example, services 1320 and/or hardware 1322) based on priority paths for different inferencing tasks of AI service(s) 1418.

In at least one embodiment, shared storage may be mounted to AI service(s) 1418 within system 1400. In at least one embodiment, shared storage may operate as a cache (or other storage device type) and may be used to process inference requests from applications. In at least one embodiment, when an inference request is submitted, a request may be received by a set of API instances of deployment system 1306, and one or more instances may be selected (for example, for best fit, for load balancing, etc.) to process a request. In at least one embodiment, to process a request, a request may be entered into a database, a machine learning model may be located from model registry 1324 if not already in a cache, a validation step may ensure appropriate machine learning model is loaded into a cache (for example, shared storage), and/or a copy of a model may be saved to a cache. In at least one embodiment, a scheduler (for example, of pipeline manager 1412) may be used to launch an application that is referenced in a request if an application is not already running or if there are not enough instances of an application. In at least one embodiment, if an inference server is not already launched to execute a model, an inference server may be launched. Any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as inference server is running as a different instance.

In at least one embodiment, during application execution, an inference request for a given application may be received, and a container (for example, hosting an instance of an inference server) may be loaded (if not already), and a start procedure may be called. In at least one embodiment, pre-processing logic in a container may load, decode, and/or perform any additional pre-processing on incoming data (for example, using a CPU(s) and/or GPU(s)). In at least one embodiment, once data is prepared for inference, a container may perform inference as necessary on data. In at least one embodiment, this may include a single inference call on one image (for example, a hand X-ray), or may require inference on hundreds of images (for example, a chest CT). In at least one embodiment, an application may summarize results before completing, which may include, without limitation, a single confidence score, pixel level-segmentation, voxel-level segmentation, generating a visualization, or generating text to summarize findings. In at least one embodiment, different models or applications may be assigned different priorities. For example, some models may have a real-time (TAT<1 min) priority while others may have lower priority (for example, TAT<10 min). In at least one embodiment, model execution times may be measured from requesting institution or entity and may include partner network traversal time, as well as execution on an inference service.

In at least one embodiment, transfer of requests between services 1320 and inference applications may be hidden behind a SDK, and robust transport may be provide through a queue. In at least one embodiment, a request will be placed in a queue via an API for an individual application/tenant ID combination and an SDK will pull a request from a queue and give a request to an application. In at least one embodiment, a name of a queue may be provided in an environment from where an SDK will pick it up. In at least one embodiment, asynchronous communication through a queue may be useful as it may allow any instance of an application to pick up work as it becomes available. Results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 1426, and an inference service may perform inferencing on a GPU.

In at least one embodiment, visualization service(s) 1420 may be leveraged to generate visualizations for viewing outputs of applications and/or deployment pipeline(s) 1410. In at least one embodiment, GPUs/Graphics 1422 may be leveraged by visualization service(s) 1420 to generate visualizations. In at least one embodiment, rendering effects, such as ray-tracing, may be implemented by visualization service(s) 1420 to generate higher quality visualizations. In at least one embodiment, visualizations may include, without limitation, 2D image renderings, 3D volume renderings, 3D volume reconstruction, 2D tomographic slices, VR displays, AR displays, etc. In at least one embodiment, virtualized environments may be used to generate a virtual interactive display or environment (for example, a virtual environment) for interaction by users of a system (for example, doctors, nurses, radiologists, etc.). In at least one embodiment, visualization service(s) 1420 may include an internal visualizer, cinematics, and/or other rendering or image processing capabilities or functionality (for example, ray tracing, rasterization, internal optics, etc.).

In at least one embodiment, hardware 1322 may include GPUs/Graphics 1422, AI system 1424, cloud 1426, and/or any other hardware used for executing training system 1304 and/or deployment system 1306. In at least one embodiment, GPUs/Graphics 1422 (for example, NVIDIA's TESLA and/or QUADRO GPUs) may include any number of GPUs that may be used for executing processing tasks of compute service(s) 1416, AI service(s) 1418, visualization service(s) 1420, other services, and/or any of features or functionality of software 1318. For example, with respect to AI service(s) 1418, GPUs/Graphics 1422 may be used to perform pre-processing on imaging data (or other data types used by machine learning models), post-processing on outputs of machine learning models, and/or to perform inferencing (for example, to execute machine learning models). In at least one embodiment, cloud 1426, AI system 1424, and/or other components of system 1400 may use GPUs/Graphics 1422. In at least one embodiment, cloud 1426 may include a GPU-optimized platform for deep learning tasks. In at least one embodiment, AI system 1424 may use GPUs, and cloud 1426—or at least a portion tasked with deep learning or inferencing—may be executed using one or more AI systems 1424. As such, although hardware 1322 is illustrated as discrete components, this is not intended to be limiting, and any components of hardware 1322 may be combined with, or leveraged by, any other components of hardware 1322.

In at least one embodiment, AI system 1424 may include a purpose-built computing system (for example, a super-computer or an HPC) configured for inferencing, deep learning, machine learning, and/or other AI tasks. In at least one embodiment, AI system 1424 (for example, NVIDIA's DGX Systems) may include GPU-optimized software (for example, a software stack) that may be executed using a plurality of GPUs/Graph 1422, in addition to CPUs, RAM, storage, and/or other components, features, or functionality. In at least one embodiment, one or more AI systems 1424 may be implemented in cloud 1426 (for example, in a data center) for performing some or all of AI-based processing tasks of system 1400.

In at least one embodiment, cloud 1426 may include a GPU-accelerated infrastructure (for example, NVIDIA's NGC) that may provide a GPU-optimized platform for executing processing tasks of system 1400. In at least one embodiment, cloud 1426 may include an AI system(s) 1424 for performing one or more of AI-based tasks of system 1400 (for example, as a hardware abstraction and scaling platform). In at least one embodiment, cloud 1426 may integrate with application orchestration system 1428 leveraging multiple GPUs to allow seamless scaling and load balancing between and among applications and services 1320. In at least one embodiment, cloud 1426 may tasked with executing at least some of services 1320 of system 1400, including compute service(s) 1416, AI service(s) 1418, and/or visualization service(s) 1420, as described herein. In at least one embodiment, cloud 1426 may perform small and large batch inference (for example, executing NVIDIA's TENSOR RT), provide a parallel computing platform 1430 (for example, NVIDIA's CUDA), execute application orchestration system 1428 (for example, KUBERNETES), provide a graphics rendering API and platform (for example, for ray-tracing, 2D graphics, 3D graphics, and/or other rendering techniques to produce higher quality cinematics), and/or may provide other functionality for system 1400.

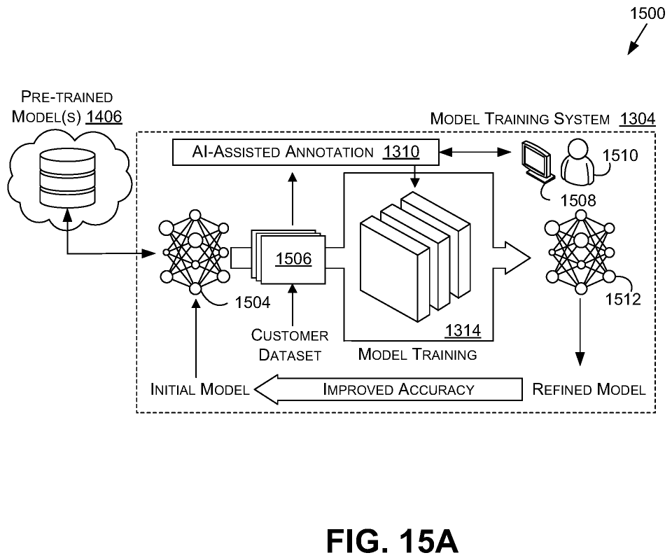

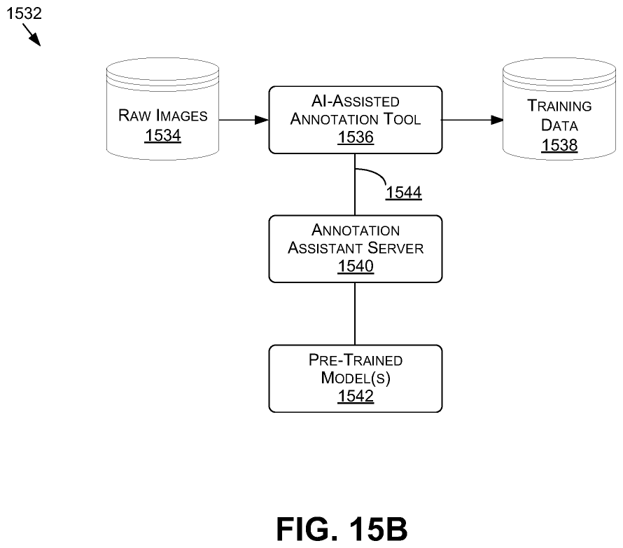

FIG. 15A illustrates a data flow diagram for a process 1500 to train, retrain, or update a machine learning model, in accordance with at least one embodiment. In at least one embodiment, process 1500 may be executed using, as a non-limiting example, system 1500 of FIG. 15A. In at least one embodiment, process 1500 may leverage services and/or hardware as described herein. In at least one embodiment, refined model 1512 generated by process 1500 may be executed by a deployment system for one or more containerized applications in deployment pipelines.

In at least one embodiment, model training 1514 may include retraining or updating an initial model 1504 (for example, a pre-trained model) using new training data (for example, new input data, such as customer dataset 1506, and/or new ground truth data associated with input data). In at least one embodiment, to retrain, or update, initial model 1504, output or loss layer(s) of initial model 1504 may be reset, deleted, and/or replaced with an updated or new output or loss layer(s). In at least one embodiment, initial model 1504 may have previously fine-tuned parameters (for example, weights and/or biases) that remain from prior training, so training or retraining may not take as long or require as much processing as training a model from scratch. In at least one embodiment, during model training 1514, by having reset or replaced output or loss layer(s) of initial model 1504, parameters may be updated and re-tuned for a new data set based on loss calculations associated with accuracy of output or loss layer(s) at generating predictions on new, customer dataset 1506.

In at least one embodiment, pre-trained models 1406 may be stored in a data store, or registry. In at least one embodiment, pre-trained models 1406 may have been trained, at least in part, at one or more facilities other than a facility executing process 1500. In at least one embodiment, to protect privacy and rights of patients, subjects, or clients of different facilities, pre-trained models 1406 may have been trained, on-premise, using customer or patient data generated on-premise. In at least one embodiment, pre-trained models 1406 may be trained using a cloud and/or other hardware, but confidential, privacy protected patient data may not be transferred to, used by, or accessible to any components of a cloud (or other off premise hardware). In at least one embodiment, where pre-trained models 1406 is trained at using patient data from more than one facility, pre-trained models 1406 may have been individually trained for each facility prior to being trained on patient or customer data from another facility. In at least one embodiment, such as where a customer or patient data has been released of privacy concerns (for example, by waiver, for experimental use, etc.), or where a customer or patient data is included in a public data set, a customer or patient data from any number of facilities may be used to train pre-trained models 1406 on-premise and/or off premise, such as in a datacenter or other cloud computing infrastructure.

In at least one embodiment, when selecting applications for use in deployment pipelines, a user may also select machine learning models to be used for specific applications. In at least one embodiment, a user may not have a model for use, so a user may select pre-trained model(s) 1406 to use with an application. In at least one embodiment, pre-trained model may not be optimized for generating accurate results on customer dataset 1506 of a facility of a user (for example, based on patient diversity, demographics, types of medical imaging devices used, etc.). In at least one embodiment, prior to deploying a pre-trained model into a deployment pipeline for use with an application(s), pre-trained model(s) 1406 may be updated, retrained, and/or fine-tuned for use at a respective facility.

In at least one embodiment, a user may select pre-trained model(s) 1406 that is to be updated, retrained, and/or fine-tuned, and this pre-trained model may be referred to as initial model 1504 for a training system within process 1500. In at least one embodiment, a customer dataset 1506 (for example, imaging data, genomics data, sequencing data, or other data types generated by devices at a facility) may be used to perform model training (which may include, without limitation, transfer learning) on initial model 1504 to generate refined model 1512. In at least one embodiment, ground truth data corresponding to customer dataset 1506 may be generated by model training system 1304. In at least one embodiment, ground truth data may be generated, at least in part, by clinicians, scientists, doctors, practitioners, at a facility.

In at least one embodiment, AI-assisted annotation 1310 may be used in some examples to generate ground truth data. In at least one embodiment, AI-assisted annotation 1310 (for example, implemented using an AI-assisted annotation SDK) may leverage machine learning models (for example, neural networks) to generate suggested or predicted ground truth data for a customer dataset. In at least one embodiment, a user may use annotation tools within a user interface (a GUI) on a computing device.

In at least one embodiment, user 1510 may interact with a GUI via computing device 1508 to edit or fine-tune (auto)annotations. In at least one embodiment, a polygon editing feature may be used to move vertices of a polygon to more accurate or fine-tuned locations.

In at least one embodiment, once customer dataset 1506 has associated ground truth data, ground truth data (for example, from AI-assisted annotation 1310, manual labeling, etc.) may be used by during model training to generate refined model 1512. In at least one embodiment, customer dataset 1506 may be applied to initial model 1504 any number of times, and ground truth data may be used to update parameters of initial model 1504 until an acceptable level of accuracy is attained for refined model 1512. In at least one embodiment, once refined model 1512 is generated, refined model 1512 may be deployed within one or more deployment pipelines at a facility for performing one or more processing tasks with respect to medical imaging data.

In at least one embodiment, refined model 1512 may be uploaded to pre-trained model(s) 1542 in a model registry to be selected by another facility. In at least one embodiment, this process may be completed at any number of facilities such that refined model 1512 may be further refined on new datasets any number of times to generate a more universal model.

FIG. 15B is an example illustration of a client-server architecture 1532 to enhance annotation tools with pre-trained model(s) 1542, in accordance with at least one embodiment. In at least one embodiment, AI-assisted annotation tool 1536 may be instantiated based on a client-server architecture 1532. In at least one embodiment, AI-assisted annotation tools 1536 in imaging applications may aid radiologists, for example, identify organs and abnormalities. In at least one embodiment, imaging applications may include software tools that help user 1510 to identify, as a non-limiting example, a few extreme points on a particular organ of interest in raw images 1534 (for example, in a 3D MRI or CT scan) and receive auto-annotated results for all 2D slices of a particular organ. In at least one embodiment, results may be stored in a data store as training data 1538 and used as (for example and without limitation) ground truth data for training. In at least one embodiment, when computing device 1508 sends extreme points for AI-assisted annotation, a deep learning model, for example, may receive this data as input and return inference results of a segmented organ or abnormality. In at least one embodiment, pre-instantiated annotation tools, such as AI-assisted annotation tool 1536 in FIG. 15B, may be enhanced by making API calls (for example, API Call 1544) to a server, such as an annotation assistant server 1540 that may include a set of pre-trained model(s) 1542 stored in an annotation model registry, for example. In at least one embodiment, an annotation model registry may store pre-trained model(s) 1542 (for example, machine learning models, such as deep learning models) that are pre-trained to perform AI-assisted annotation 1310 on a particular organ or abnormality. These models may be further updated by using training pipelines. In at least one embodiment, pre-installed annotation tools may be improved over time as new labeled data is added.

Various embodiments can be described by the following clauses:

1. A computer-implemented method, comprising:
obtaining, for a data volume corresponding to a scene to be rendered, density information for a plurality of macrocells associated with respective partitions of the data volume;
selecting a light ray to be traced through the plurality of macrocells;
determining, using a random number generator with a first maximum density of a first macrocell and a second maximum density of a second macrocell, one or more step sizes to be used to determine sample locations for the light ray in the first macrocell and the second macrocell;
determining that none of the sample locations are located within the second macrocell; and
forwarding information for the light ray from the first macrocell to a third macrocell through which the light ray is to be traced, without forwarding the information for the light ray to the second macrocell, wherein volume sampling will be performed for the light ray in the third macrocell but not the second macrocell, and wherein the third macrocell is adjacent to or distant from the second macrocell.

2. The computer-implemented method of clause 1, wherein the information for the light ray is forwarded to the third macrocell after determining that the light ray will be sampled in the third macrocell.

3. The computer-implemented method of clause 1, further comprising:
determining an actual density value corresponding to a first step size; and
rejecting a sample value corresponding to the first step size if the actual density value is more than a threshold amount lower than the maximum density for the first macrocell.

4. The computer-implemented method of clause 1, wherein the one or more step sizes correspond to one or more Woodcock step sizes.

5. The computer-implemented method of clause 1, wherein the individual macrocells further include a plurality of cells associated with points in the data volume.

6. The computer-implemented method of clause 1, wherein the data volume is a structured data volume or an unstructured data volume.

7. The computer-implemented method of clause 1, wherein the one or more step sizes are sampled from an exponential distribution.

8. The computer-implemented method of clause 1, wherein the data volume is associated with an acceleration structure to be used to calculate the first maximum density and the second maximum density.

9. The computer-implemented method of clause 1, wherein the first sample location for the light ray is determined to be in the third macrocell, and wherein the tracing of the ray is allowed to begin from the third macrocell.

10. A processor, comprising:
one or more circuits to:
   obtain, for a data volume corresponding to a scene to be rendered, density information for each of a plurality of macrocells corresponding to partitions of the data volume;
   select a light ray to be traced through the plurality of macrocells;
   determine, using random numbers with a first maximum density of a first macrocell and a second maximum density of a second macrocell, one or more step sizes to be used for sampling the light ray in the first macrocell and the second macrocell;
   determine, based at least in part upon the one or more step sizes, that the light ray will pass from the first macrocell without being sampled in the second macrocell; and
   forward information for the light ray to processor for a third macrocell through which the light ray is to be traced, without forwarding the information for the light ray to a processor associated with the second macrocell, wherein volume sampling will not be performed for the light ray using the processor for the second macrocell and wherein the third macrocell is adjacent to or distant from the second macrocell in the data volume.

11. The processor of clause 10, wherein the information for the light ray is forwarded to the third macrocell after determining that the light ray will be sampled in the third macrocell.

12. The processor of clause 10, wherein the one or more circuits are further to:
determine an actual density value corresponding to a first step size; and
reject a sample value corresponding to the first step size if the actual density value is more than a threshold amount lower than the maximum density for the first macrocell.

13. The processor of clause 10, wherein the one or more step sizes correspond to one or more Woodcock step sizes.

14. The processor of clause 10, wherein the individual macrocells further include a plurality of cells associated with points in the data volume.

15. The processor of clause 10, wherein the processor is comprised in at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for performing generative operations using a language model;
a system for synthetic data generation;
a system for performing generative AI operations using a large language model (LLM),
a collaborative content creation platform for 3D assets; or
a system implemented at least partially using cloud computing resources.

16. A system, comprising:
one or more processing units to use a random number generator and maximum density values, for a plurality of macrocells for a scene to be rendered, to determine steps sizes to be used for a ray to be traced through the plurality of macrocells, the step sizes to be used to determine one or more macrocells to which to forward information for the light ray based, at least in part, upon a determination of a light sampling being performed in the one or more macrocells at sample locations corresponding to the step sizes.

17. The system of clause 16, wherein the information for the light ray is forwarded to the third microcell after determining that the light ray is to be sampled in the third microcell.

18. The system of clause 16, wherein the one or more circuits are further to:
determine an actual density value corresponding to a first step size; and
reject a sample value corresponding to the first step size if the actual density value is more than a threshold amount lower than the maximum density for the first microcell.

19. The system of clause 16, wherein the individual macrocells further include a plurality of cells associated with points in the data volume.

20. The system of clause 16, wherein the system comprises at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system for performing generative AI operations using a large language model (LLM),
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for performing generative operations using a language model;
a system for synthetic data generation;
a collaborative content creation platform for 3D assets; or
a system implemented at least partially using cloud computing resources.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. Term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. Use of term “set” (for example, “a set of items”) or “subset,” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, term “plurality” indicates a state of being plural (for example, “a plurality of items” indicates multiple items). A plurality is at least two items, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (for example, executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (for example, a propagating transient electric or electromagnetic transmission) but includes non-transitory data storage circuitry (for example, buffers, cache, and queues) within transceivers of transitory signals. In at least one embodiment, code (for example, executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. A set of non-transitory computer-readable storage media, in at least one embodiment, comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main CPU executes some of instructions while a GPU executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that allow performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (for example, “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. Terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. Obtaining, acquiring, receiving, or inputting analog and digital data can be accomplished in a variety of ways such as by receiving data as a parameter of a function call or a call to an application programming interface. In some implementations, process of obtaining, acquiring, receiving, or inputting analog or digital data can be accomplished by transferring data via a serial or parallel interface. In another implementation, process of obtaining, acquiring, receiving, or inputting analog or digital data can be accomplished by transferring data via a computer network from providing entity to acquiring entity. References may also be made to providing, outputting, transmitting, sending, or presenting analog or digital data. In various examples, process of providing, outputting, transmitting, sending, or presenting analog or digital data can be accomplished by transferring data as an input or output parameter of a function call, a parameter of an API or interprocess communication mechanism.

Although discussion above sets forth example implementations of described techniques, other architectures may be used to implement described functionality, and are intended to be within scope of this disclosure. Furthermore, although specific distributions of responsibilities are defined above for purposes of discussion, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A computer-implemented method, comprising:
obtaining, for a data volume corresponding to a scene to be rendered, density information for a plurality of macrocells associated with respective partitions of the data volume;
selecting a light ray to be traced through the plurality of macrocells;
determining, using a random number generator with a first maximum density of a first macrocell and a second maximum density of a second macrocell, one or more step sizes to be used to determine sample locations for the light ray in the first macrocell and the second macrocell;
determining that none of the sample locations are located within the second macrocell; and
forwarding information for the light ray from the first macrocell to a third macrocell through which the light ray is to be traced, without forwarding the information for the light ray to the second macrocell, wherein volume sampling will be performed for the light ray in the third macrocell but not the second macrocell, and wherein the third macrocell is adjacent to or distant from the second macrocell.

2. The computer-implemented method of claim 1, wherein the information for the light ray is forwarded to the third macrocell after determining that the light ray will be sampled in the third macrocell.

3. The computer-implemented method of claim 1, further comprising:
determining an actual density value corresponding to a first step size; and
rejecting a sample value corresponding to the first step size if the actual density value is more than a threshold amount lower than the maximum density for the first macrocell.

4. The computer-implemented method of claim 1, wherein the one or more step sizes correspond to one or more Woodcock step sizes.

5. The computer-implemented method of claim 1, wherein the individual macrocells further include a plurality of cells associated with points in the data volume.

6. The computer-implemented method of claim 1, wherein the data volume is a structured data volume or an unstructured data volume.

7. The computer-implemented method of claim 1, wherein the one or more step sizes are sampled from an exponential distribution.

8. The computer-implemented method of claim 1, wherein the data volume is associated with an acceleration structure to be used to calculate the first maximum density and the second maximum density.

9. The computer-implemented method of claim 1, wherein the first sample location for the light ray is determined to be in the third macrocell, and wherein the tracing of the ray is allowed to begin from the third macrocell.

10. A processor, comprising:
one or more circuits to:
obtain, for a data volume corresponding to a scene to be rendered, density information for each of a plurality of macrocells corresponding to partitions of the data volume;
select a light ray to be traced through the plurality of macrocells;
determine, using random numbers with a first maximum density of a first macrocell and a second maximum density of a second macrocell, one or more step sizes to be used for sampling the light ray in the first macrocell and the second macrocell;
determine, based at least in part upon the one or more step sizes, that the light ray will pass from the first macrocell without being sampled in the second macrocell; and
forward information for the light ray to processor for a third macrocell through which the light ray is to be traced, without forwarding the information for the light ray to a processor associated with the second macrocell, wherein volume sampling will not be performed for the light ray using the processor for the second macrocell and wherein the third macrocell is adjacent to or distant from the second macrocell in the data volume.

11. The processor of claim 10, wherein the information for the light ray is forwarded to the third macrocell after determining that the light ray will be sampled in the third macrocell.

12. The processor of claim 10, wherein the one or more circuits are further to:
determine an actual density value corresponding to a first step size; and
reject a sample value corresponding to the first step size if the actual density value is more than a threshold amount lower than the maximum density for the first macrocell.

13. The processor of claim 10, wherein the one or more step sizes correspond to one or more Woodcock step sizes.

14. The processor of claim 10, wherein the individual macrocells further include a plurality of cells associated with points in the data volume.

15. The processor of claim 10, wherein the processor is comprised in at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for performing generative operations using a language model;
a system for synthetic data generation;
a system for performing generative AI operations using a large language model (LLM), a collaborative content creation platform for 3D assets; or a system implemented at least partially using cloud computing resources.

16. A system, comprising:
one or more processing units to use a random number generator and maximum density values, for a plurality of macrocells for a scene to be rendered, to determine steps sizes to be used for a ray to be traced through the plurality of macrocells, the step sizes to be used to determine one or more macrocells to which to forward information for the light ray based, at least in part, upon a determination of a light sampling being performed in the one or more macrocells at sample locations corresponding to the step sizes.

17. The system of claim 16, wherein the information for the light ray is forwarded to the third microcell after determining that the light ray is to be sampled in the third microcell.

18. The system of claim 16, wherein the one or more circuits are further to:
determine an actual density value corresponding to a first step size; and
reject a sample value corresponding to the first step size if the actual density value is more than a threshold amount lower than the maximum density for the first microcell.

19. The system of claim 16, wherein the individual macrocells further include a plurality of cells associated with points in the data volume.

20. The system of claim 16, wherein the system comprises at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system for performing generative AI operations using a large language model (LLM), a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for performing generative operations using a language model;
a system for synthetic data generation;
a collaborative content creation platform for 3D assets; or
a system implemented at least partially using cloud computing resources.
